(19) United States
(12) Patent Application Publication
(10) Pub. No.: US 2023/0287627 A1
(43) Pub. Date: Sep. 14, 2023

(54) Recyclable Composition for Paper Coating

(71) Applicant: BASF SE, Ludwigshafen am Rhein (DE)

(72) Inventors: Pirro CIPI, Wyandotte, MI (US); Amirpouyan SARDASHTI, Charlotte, NC (US); Frank REINHOLD, Wyandotte, MI (US); Daniel Scott NIEDZWIECKI, Wyandotte, MI (US); Kevin PAYNE, Wyandotte, MI (US); Nathaniel Troy GREENE, Charlotte, NC (US); Alex RUDD, Cypress, TX (US)

(21) Appl. No.: 18/004,529

(22) PCT Filed: Jul. 9, 2021
(86) PCT No.: PCT/EP2021/069199

§ 371 Date: Jan. 6, 2023

Related U.S. Application Data
(60) Provisional application No. 63/050,132, filed on Jul. 10, 2020.

(51) Int. Cl. D21H 19/22; C09D 125/14; C09D 133/06; C09D 7/63; C09D 7/65; D21H 19/18; D21H 21/16; D21H 27/10

(52) U.S. Cl. CPC D21H 19/22; C09D 7/63; C09D 7/65; C09D 125/14; C09D 133/062; D21H 19/18; D21H 21/16; D21H 27/10

(57) ABSTRACT

Disclosed herein is a composition that can provide moisture barrier during packaging. Additionally disclosed herein is a substrate coated with the composition that is recyclable and repulpable. The composition includes at least one ester and at least one styrene acrylic copolymer with a glass transition temperature in the range of from -54° C. to 10° C.

### FIELD OF THE DISCLOSURE

The present invention relates to a composition that can provide moisture barrier during packaging. In addition, the present invention relates to a substrate coated with the composition that is recyclable and repulpable.

### BACKGROUND OF THE INVENTION

In the packaging industry, packaging materials based on paper, cardboard or paperboard are frequently provided with a coating to increase the impermeability of water vapor and food flavors. Polyethylene films and wax coatings are generally used to laminate or coat paper and are widely used in packaging applications to protect paper products from moisture and provide water resistance. Wax-coated paper products, particularly wax-coated corrugated paperboard containers have been used for several years to ship and store fresh, perishable foods. The containers are packed with crushed ice to keep the food cool during shipping and storage and the wax imparts water and moisture resistance to the containers.

Typically, paraffin wax is used on corrugated boxes to render them hydrophobic and mechanically resistant to environmental conditions during food transport along the supply chain from source to the grocery store. Once the paraffin wax is applied to corrugated boxes it renders them non-repulpable and non-recyclable and they must be discarded in the general urban waste stream. Similarly, recycling of packaging containing polyethylene films are limited and expensive since special equipment is required for repulping.

A number of wax-coated or wax-impregnated paperboard containers have been recently reported. In the state of the art, coating compositions comprising wax or paraffin wax for coating corrugated boxes are known and described, for instance, in the following references.

U.S. 3,892,613 A discloses a method of manufacturing wax impregnated single face corrugated paperboard which includes the steps of moisture conditioning a first side of corrugating medium and impregnating the second side of the corrugating medium with wax prior to forming the corrugated paperboard.

U.S. 3,874, 905 A discloses a process for coating liners of corrugated paperboards. The raw paper is coated with a styrene-butadiene rubber latex, dried and cured. A heavier coating of paraffin wax is applied over the rubber coat to form wax coated paper products having water resistance.

U.S. 4,017,016 A discloses a corrugated paper board of which the container is formed is preferably of the type which is a wax, or an oil coated so as to increase the water retaining capabilities and to maintain the strength of the container when subjected to water for a longer period of time.

U.S. 4,126,225 A discloses a poultry container formed from a single blank of wax saturated paperboard material adhesively joined along a joint, wherein the paperboard is saturated with wax so as to make the container waterproof.

U.S. 5,539,035 A discloses a wax composition for coating paper products, wherein the wax composition contains a wax base and a polymeric additive. The wax base comprises a paraffin wax and a fatty acid. The polymeric additive is a polymeric amorphous substance soluble in or miscible with the wax base.

US 5,763,100 A discloses a paper stock comprising a substrate coated on at least one surface with a water-based emulsion coating. The water-based emulsion coating comprises 20-90 dry wt. % of an acrylic-styrene copolymer and 5-70 dry wt. % of a wax selected from the group consisting of paraffin wax, microcrystalline wax, polyethylene wax and a blend of two or more of said waxes.

The methods and compositions disclosed in the prior arts have limitations. Although packaging materials comprising paraffin wax or polyethylene perform well in providing water and moisture resistance but are not acceptable from environmental impact point of view. The coating compositions and wax-coated containers described in the prior art are not recycled or are not recyclable. Both polyethylene films and most wax coatings do not degrade if the package is composted and pose problems on disposal. In view of the large quantity of wax-coated containers which are used each year, it would be highly desirable to recycle the containers rather than discarding them into waste. There are several problems inherent in recycling wax-coated containers. First, the purpose of wax is to impart water and moisture resistance to the container and this property directly interferes with the essential property of solubility and/or ability to degrade required in a recyclable container. Second, in removing the wax coating, a wax residue may remain on or contaminate the paper fibers. This residue weakens the strength of the recycled sheet because it prevents or reduces the amount of inherent bonding which can be achieved in the sheet. Third, due to high melting point of the ‘many of the waxes conventionally used on wax-coated containers and such coating compositions, in order to remove the coating, it is necessary to modify the industry standard repulping conditions to use higher repulping temperatures. This can lead to increased energy costs which detracts from the profitability of recycling,

Therefore, there is a need for an improved composition that can be coated on paper products to make the paper products recyclable under standard repulping conditions as described in the experimental section for test methods, while at the same time providing the needed water resistance, block resistance and viscosity.

Hence, it is an object of the presently claimed invention to provide a composition for coating of paper and paper products which imparts the necessary block resistance, water resistance and viscosity but which does not impair the recyclability and repulpability of the paper and the paper products.

### SUMMARY OF THE INVENTION

Surprisingly, it has been found that the above-identified object is met by providing a composition comprising (i) at least one ester obtained by reacting at least one compound having 2 to 12 hydroxy groups and at least one C₆-C₂₄ monocarboxylic acid and (ii) at least one first styrene acrylic copolymer with a glass transition temperature in the range of from - 54 to 10° C., measured by differential scanning calorimetry according to ASTM D 7426 (2013).

Accordingly, in one aspect, the presently claimed invention is directed to a composition comprising:
(i) at least one ester obtained by reacting at least one compound having 2 to 12 hydroxy groups and at least one C₆-C₂₄ monocarboxylic acid, and
(ii) at least one first styrene acrylic copolymer with a glass transition temperature in the range of from - 54° C. to 10° C., measured by differential scanning calorimetry according to ASTM D 7426 (2013).

In another aspect, the presently claimed invention is directed to a process for preparing the composition disclosed herein.

In still another aspect, the presently claimed invention is directed to a coating comprising the composition disclosed herein.

In yet another aspect, the presently claimed invention is directed to a substrate coated on at least one surface with a coating disclosed herein.

In a further aspect, the presently claimed invention is directed to a paperstock comprising a substrate coated with the coating disclosed herein.

### DETAILED DESCRIPTION OF THE INVENTION

The presently claimed invention is not to be limited in terms of the embodiments described in this application. Modifications and variations can be made without departing from its spirit and scope, as will be apparent to those skilled in the art. Functionally equivalent methods, formulations, and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to methods, reagents, compounds, or compositions, which can, of course, vary. It is also to be understood that the terminology used herein is for the purpose of describing embodiments only and is not intended to be limiting.

The terms “comprising”, “comprises” and “comprised of′ as used herein are synonymous with “including”, “includes” or “containing”, “contains”, and are inclusive or open-ended and do not exclude additional, non-recited members, elements or method steps. It will be appreciated that the terms “comprising”, “comprises” and “comprised of′ as used herein comprise the terms “consisting of’, “consists” and “consists of’.

Furthermore, the terms “first”, “second”, “third” or “(a)”, “(b)”, “(c)”, “(d)” etc. and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein. In case the terms “first”, “second”, “third” or “(A)”, “(B)” and “(C)” or “(a)”, “(b)”, “(c)”, “(d)”, “i”, “ii” etc. relate to steps of a method or use or assay there is no time or time interval coherence between the steps, that is, the steps may be carried out simultaneously or there may be time intervals of seconds, minutes, hours, days, weeks, months or even years between such steps, unless otherwise indicated in the application as set forth herein above or below.

For the purposes of the presently claimed invention, all ranges disclosed herein also encompass any and all possible subranges and combinations of subranges thereof. The ranges defined throughout the specification include the end values as well, i.e. a range of 1 to 10 implies that both 1 and 10 are included in the range. For the avoidance of doubt, the applicant shall be entitled to any equivalents according to applicable law. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

The use of the terms “a”, “an”, “the”, and similar referents in the context of describing the materials and methods discussed herein (especially in the context of the following claims) are to be construed to cover both the singular and the plural, unless otherwise indicated herein or clearly contradicted by context.

The term “about” used throughout this specification is used to describe and account for small fluctuations. For example, the term “about” refers to less than or equal to ±5%, such as less than or equal to ±2%, less than or equal to ±1%, less than or equal to ±0.5%, less than or equal to ±0.2%, less than or equal to ±0.1% or less than or equal to ±0.05%. All numeric values herein are modified by the term “about,” whether explicitly indicated. A value modified by the term “about” of course includes the specific value. For instance, “about 5.0” or “about 5” must include 5.0 or 5.

In the following passages, different aspects of the subject matter are defined in more detail. Each aspect so defined may be combined with any other aspect or aspects unless clearly indicated to the contrary. Any feature indicated as being preferred or advantageous may be combined with any other feature or features indicated as being preferred or advantageous.

Reference throughout this specification to “one embodiment” or “an embodiment” means that a feature, structure or characteristic described in connection with the embodiment is included in at least one embodiment of the presently claimed invention. Thus, appearances of the phrases “in one embodiment” or “in an embodiment” in various places throughout this specification are not necessarily all referring to the same embodiment but may refer. Furthermore, the features, structures or characteristics may be combined in any suitable manner, as would be apparent to a person skilled in the art from this disclosure, in one or more embodiments. Furthermore, while some embodiments described herein include some, but not other features included in other embodiments, combinations of features of different embodiments are meant to be within the scope of the subject matter, and form different embodiments, as would be understood by those in the art. For example, in the appended claims, any of the claimed embodiments can be used in any combination.

Although the embodiments disclosed herein have been described with reference to embodiments it is to be understood that these embodiments are merely illustrative of the principles and applications of the presently claimed invention. It will be apparent to those skilled in the art that various modifications and variations can be made to the methods and apparatus of the presently claimed invention without departing from the spirit and scope of the presently claimed invention. Thus, it is intended that the presently claimed invention include modifications and variations that are within the scope of the appended claims and their equivalents, and the above-described embodiments are presented for purposes of illustration and not of limitation. All patents and publications cited herein are incorporated by reference herein for the specific teachings thereof as noted, unless other statements of incorporation are specifically provided.

All methods described herein can be performed in any suitable order unless otherwise indicated herein or otherwise clearly contradicted by context. The use of any and all examples, or exemplary language (e.g., “such as”) provided herein, is intended merely to better illustrate the materials and methods and does not pose a limitation on the scope unless otherwise claimed.

For the purposes of the presently claimed invention, the term “aqueous” or “water-borne” as used herein refers to the presence of a significant fraction of water as the main continuous medium besides organic solvents or 100 percentage content of water. Within the continuous water phase exist dissolved polymers that create a homogenous solution with both the polymer and water as the continuous medium or as a dispersed emulsion of the polymers in water that create a heterogenous solution with water as the continuous medium.

Reference throughout this specification to the term “copolymer” means that the copolymer comprises block or random copolymers obtainable by radical polymerization.

The use of (meth) in a monomer or repeat unit indicates an optional methyl group.

For purposes of the presently claimed invention, the term acrylate or (meth)acrylate refers to acrylic or methacrylic acid, esters of acrylic or methacrylic acid, and salts, amides, and other suitable derivatives of acrylic or methacrylic acid, and mixtures thereof. Illustrative examples of suitable (meth)acrylic monomers include, without limitation, the following meth acrylate esters: methyl methacrylate, ethyl methacrylate, n-propyl methacrylate, n-butyl methacrylate (BMA), isopropyl methacrylate, isobutyl methacrylate, n-amyl methacrylate, n-hexyl methacrylate, isoamyl methacrylate, 2-hydroxyethyl methacrylate, 2-hydroxypropyl methacrylate, N,N-dimethylaminoethyl methacrylate, N,N-diethylamino ethyl methacrylate, t-butylaminoethyl methacrylate, 2-sul foethyl methacrylate, trifluoroethyl methacrylate, glycidyl methacrylate (GMA), benzyl methacrylate, allyl methacrylate, 2-n-butoxyethyl methacrylate, 2-chloroethyl methacrylate, sec-butyl-methacrylate, tert-butyl methacrylate, 2-ethylbutyl methacrylate, cinnamyl methacrylate, crotyl methacrylate, cyclohexyl methacrylate, cyclopentyl meth acrylate, 2-ethoxyethyl methacrylate, furfuryl methacrylate, hexafluoroisopropyl methacrylate, methallyl methacrylate, 3-methoxybutyl methacrylate, 2-methoxybutyl methacrylate, 2-nitro-2-methylpropyl methacrylate, n-octylmethacrylate, 2-ethylhexyl methacrylate, 2-phenoxyethyl methacrylate, 2-phenylethyl methacrylate, phenyl methacrylate, propargyl methacrylate, tetrahydrofurfuryl methacrylate and tetrahydropyranyl methacrylate. Example of suitable acrylate esters include, without limitation, methyl acrylate, ethyl acrylate, n-propyl acrylate, isopropyl acrylate, n-butyl acrylate (BA), n-decyl acrylate, isobutyl acrylate, n-amyl acrylate, n-hexyl acrylate, isoamyl acrylate, 2-hydroxyethyl acrylate, 2-hydroxypropyl acrylate, N,N-dimethylaminoethyl acrylate, N,N-diethylaminoethyl acrylate, t-butylaminoethyl acrylate, 2-sulfoethyl acrylate, trifluoroethyl acrylate, glycidyl acrylate, benzyl acrylate, allyl acrylate, 2-n butoxyethyl acrylate, 2-chloroethyl acrylate, sec-butyl acrylate, tert-butyl acrylate, 2-ethylbutyl acrylate, cinnamyl acrylate, crotyl acrylate, cyclohexyl acrylate, cyclopentyl acrylate, 2-ethoxyethyl acrylate, furfuryl acrylate, hexaflu oroisopropyl acrylate, methallyl acrylate, 3-methoxybutyl acrylate, 2-methoxybutyl acrylate, 2-nitro-2-methylpropyl acrylate, n-octylacrylate, 2-ethylhexyl acrylate, 2-phenoxy ethyl acrylate, 2-phenylethyl acrylate, phenyl acrylate, propargyl acrylate, tetrahydrofurfuryl acrylate and tetrahydropyranyl acrylate.

The term “water barrier” or “water resistance” as used herein refers to an increase in resistance of paper or paper products to water or aqueous liquids.

The term “block resistance” as disclosed herein refers to the capability of the coating when applied to two surfaces not to stick or adhere to itself upon contact or when pressure is applied.

The term “paper-based” substrate or “paperboard” substrate or “paper product” as used herein refers to any type of cellulosic fiber-based product which can folded manually or mechanically. The presently claimed invention encompasses paper and paper products made of either single or multiple layers, e.g., a paper laminate, corrugated paper.

The term “repulping” or “repulpable” or “repulpability” used interchangeably herein is the ability of the coated paper or paperboard substrate to undergo the operation of re-wetting and fiberizing for subsequent paper sheet formation.

The term “recycling” or “recyclable” or “recyclability” used interchangeably herein is the ability of used treated paper and paperboard to be processed into new paper and paperboard.

The term “coating” as used herein refers to any surface treatment applied to paper. For the purposes of the presently claimed invention, the coating according to the presently claimed invention can be applied to paper or paperboard by any conventional coating and surface sizing technique. The technique includes but is not limited to, size press, tub, gate roll and spray applicators.

For the purposes of the presently claimed invention, “glass transition temperature” or “Tg” refers to estimated Tg of a polymer or a copolymer calculated using the Fox equation. The Fox equation can be used to estimate the glass transition temperature of a polymer or copolymer as described, for example, in L. H. Sperling, “Introduction to Physical Polymer Science”, 2nd Edition, John Wiley & Sons, New York, p. 357 (1992) and T. G. Fox, Bull. Am. Phys. Soc, 1, 123 (1956), both of which are incorporated herein by reference. For example, the theoretical glass transition temperature of a copolymer derived from monomers a, b, ..., and i can be calculated according to the equation below, where wₐ is the weight fraction of monomer a in the copolymer, T_{ga} is the glass transition temperature of a homopolymer of monomer a, w is the weight fraction of monomer b in the copolymer, T_{gb} is the glass transition temperature of a homopolymer of monomer b, wᵢ is the weight fraction of monomer i in the copolymer, T_{gi} is the glass transition temperature of a homopolymer of monomer i, and Tg is the theoretical glass transition temperature of the copolymer derived from monomers a, b, ..., and i.

$$\frac{\text{1}}{{\text{T}}_{\text{g}}} = \frac{{\text{w}}_{\text{a}}}{{\text{T}}_{\text{ga}}} + \frac{{\text{w}}_{\text{b}}}{{\text{T}}_{\text{gb}}} + ⋯ + \frac{{\text{w}}_{\text{i}}}{{\text{T}}_{\text{gi}}}$$

The term ‘% by weight’ or ‘wt.% ‘as used in the presently claimed invention is with respect to the total weight of the composition. Further, the sum of wt.-% of all the compounds, as described hereinbelow, in the respective component adds up to 100 wt.-%.

For the purposes of the presently claimed invention, the mass or weight average (Mw) and number-average (Mn) molecular weight are determined by means of gel permeation chromatography at 40° C., using a high-performance liquid chromatography pump and a refractive index detector. The eluent used was tetrahydrofuran with an elution rate of 1 ml/min. The calibration is carried out by means of polystyrene standards.

The above-mentioned measurement techniques are well known to a person skilled in the art and therefore do not limit the presently claimed invention.

An aspect of the presently claimed invention is embodiment 1, directed towards a composition comprising:
(i) at least one ester obtained by reacting at least one compound having 2 to 12 hydroxy groups and at least one C₆-C₂₄ monocarboxylic acid; and
(ii) at least one first styrene acrylic copolymer with a glass transition temperature in the range of from - 54° C. to 10° C., measured by differential scanning calorimetry according to ASTM D 7426 (2013).

In an embodiment of the presently claimed invention, the composition in the embodiment 1 is characterized with the melt viscosity in the range of 100 cP to 2000 cP at temperature in the range of 90° C. to 150° C., determined according to method ASTM 2196-18.

In another embodiment of the presently claimed invention, the composition in the embodiment 1 is characterized with melt viscosity of the composition is in the range of 100 cP to 2000 cP at temperature in the range of 90° C. to 130° C., determined according to method ASTM 2196-18.

In an embodiment of the presently claimed invention, the composition in the embodiment 1 is characterized with the weight average molecular weight in the range of 600 g/mol to 25,000 g/mol, measured by gel permeation chromatography according to ISO 13885-1(2008). In another embodiment of the presently claimed invention, the composition in the embodiment 1 is characterized with the weight average molecular weight in the range of 600 g/mol to 8000 g/mol, measured by gel permeation chromatography according to ISO 13885-1(2008).

In an embodiment of the presently claimed invention, the at least one ester in the composition in the embodiment 1 has a melting point in the range of 50° C. to 90° C., determined according to ASTM D3418-15. In another embodiment of the presently claimed invention, the at least one ester in the composition in the embodiment 1 has a melting point in the range of 50° C. to 85° C., in another embodiment, it is in the range of 50° C. to 80° C., or in the range of 50° C. to 75° C., or in the range of 50° C. to 70° C., or in the range of 50° C. to 65° C., in each case determined according to ASTM D3418-15.

In an embodiment of the presently claimed invention, the at least one ester in the composition in the embodiment 1 has a weight average molecular weight in the range of 600 g/mol to 3000 g/mol, measured by gel permeation chromatography according to ISO 13885-1 (2008). In another embodiment of the presently claimed invention, the at least one ester in the composition in the embodiment 1 has a weight average molecular weight in the range of 650 g/mol to 3000 g/mol, in another embodiment, in the range of 700 g/mol to 3000 g/mol, or in the range of 750 g/mol to 3000 g/mol, or in the range of 800 g/mol to 3000 g/mol, or in the range of 850 g/mol to 3000 g/mol, or in the range of 900 g/mol to 3000 g/mol, or in the range of 1000 g/mol to 3000 g/mol, or in the range of 650 g/mol to 2500 g/mol, or in the range of 650 g/mol to 2000 g/mol, in each case measured by gel permeation chromatography according to ISO 13885-1 (2008).

In an embodiment of the presently claimed invention, the at least one ester in the composition in the embodiment 1 has an acid value in the range of 5 mg KOH/g to 30 mg KOH/g, determined according to ASTM D1980-87. In another embodiment of the presentlyclaimed invention, the at least one ester in the composition in the embodiment 1 has an acid value in the range of 5 mg KOH/g to 25 mg KOH/g, in another embodiment, in the range of 5 mg KOH/g to 20 mg KOH/g, or in the range of 10 mg KOH/g to 30 mg KOH/g, in each case determined according to ASTM D1980-87.

In an embodiment of the presently claimed invention, the at least one ester in the composition in the embodiment 1 is selected from the group consisting of pentaerythritol tetrastearate, pentaerythritol oleate, pentaerythritol tetrabehenate, pentaerythritol tetraisopalmitate, glyceryl tristearate, erythritol distearate, sorbitan stearate and dipentaerythritol stearate. In another embodiment of the presently claimed invention, the ester in the composition in the embodiment 1 is selected from the group consisting of pentaerythritol tetrastearate, pentaerythritol oleate, pentaerythritol tetrabehenate, pentaerythritol tetraisopalmitate and dipentaerythritol stearate. In another embodiment of the presently claimed invention, the ester in the composition in the embodiment 1 is pentaerythritol tetrastearate.

In an embodiment of the presently claimed invention, the at least one ester in the composition in the embodiment 1 is present in an amount in the range of 20 wt.% to 70 wt.%, based on the total weight of the coating composition. In another embodiment of the presently claimed invention, the at least one ester in the composition in the embodiment 1 is present in an amount in the range of 20 wt.% to 65 wt.%, in another embodiment, in the range of 25 wt.% to 70 wt.%, or in the range of 28 wt.% to 69 wt.%, or in the range of 30 wt.% to 70 wt.%, or in the range of 35 wt.% to 70 wt.%, or in the range of 40 wt.% to 70 wt.%, or in the range of 45 wt.% to 70 wt.%, or in the range of 50 wt.% to 70 wt.%, or in the range of 25 wt.% to 65 wt.%, in each based on the total weight of the coating composition.

In an embodiment of the presently claimed invention, the at least one compound having 2 to 12 hydroxy groups in embodiment 1 is selected from the group consisting of ethylene glycol, glycerol, erythritol, pentaerythritol, mesoerythritol, 1,2,6-hexanetriol, sorbitol, trimethylolpropane, 1,2,4-butanetriol, trimethylolethane, arabitol, xylitol, mannitol, dipentaerythritol, monosaccharides, disaccharides and polysaccharides.

In an embodiment of the presently claimed invention, the at least one compound having 2 to 12 hydroxy groups in embodiment 1 is selected from monosaccharides selected from the group consisting of ribose, ribulose, arabinose, xylose, lyxose, glucose, fructose, galactose, mannose and sorbose.

In an embodiment of the presently claimed invention, the at least one compound having 2 to 12 hydroxy groups in embodiment 1 is selected from polysaccharides selected from the group consisting of dextrin and maltodextrin.

In an embodiment of the presently claimed invention, the at least one compound having 2 to 12 hydroxy groups in embodiment 1 is selected from disaccharides selected from the group consisting of maltose, lactose and sucrose.

In an embodiment of the presently claimed invention, the at least one compound having 2 to 12 hydroxy groups in embodiment 1 has 2 to 4 hydroxy groups.

In an embodiment of the presently claimed invention, the at least one compound having 2 to 12 hydroxy groups in embodiment 1 is selected from the group consisting of ethylene glycol, glycerol, erythritol, pentaerythritol, mesoerythritol, 1,2,6-hexanetriol and trimethylolpropane.

In an embodiment of the presently claimed invention, the at least one compound having 2 to 12 hydroxy groups in embodiment 1 has 2 hydroxy groups.

In an embodiment of the presently claimed invention, the at least one compound having 2 to 12 hydroxy groups in embodiment 1 has 2 hydroxy groups is selected from the group consisting of ethylene glycol, propylene glycol, butylene glycol, 1,5-pentanediol and 1,6-hexanediol.

In an embodiment of the presently claimed invention, the at least one compound having 2 to 12 hydroxy groups in embodiment 1 is ethylene glycol.

In another embodiment of the presently claimed invention, the at least one compound having 2 to 12 hydroxy groups in embodiment 1 has 3 or 4 hydroxy groups.

In a yet another embodiment of the presently claimed invention, the at least one compound having 2 to 12 hydroxy groups in embodiment 1 has 3 or 4 hydroxy groups is selected from the group consisting of glycerol, erythritol, pentaerythritol, mesoerythritol, 1,2,6-hexanetriol and trimethylolpropane.

In an embodiment of the presently claimed invention, the at least one compound having 2 to 12 hydroxy groups in embodiment 1 has 4 hydroxy groups. In an embodiment of the presently claimed invention, the at least one compound having 2 to 12 hydroxy groups in embodiment 1 has 4 hydroxy groups is selected from the group consisting of pentaerythritol, ribose, ribulose, arabinose, xylose, erythritol and mesoerythritol. In an embodiment of the presently claimed invention, the at least one compound having 2 to 12 hydroxy groups in embodiment 1 has 4 hydroxy groups is selected from pentaerythritol, erythritol and mesoerythritol. In an embodiment of the presently claimed invention, the at least one compound having 2 to 12 hydroxy groups in embodiment 1 has 4 hydroxy groups is pentaerythritol.

In an embodiment of the presently claimed invention, the at least one compound having 2 to 12 hydroxy groups in embodiment 1 has a weight average molecular weight in the range of 90 g/mol to 3000 g/mol measured by gel permeation chromatography according to ISO 13885-1 (2008). In another embodiment of the presently claimed invention, the at least one compound having 2 to 12 hydroxy groups in embodiment 1 has a weight average molecular weight in the range of 90 g/mol to 2500 g/mol measured by gel permeation chromatography according to ISO 13885-1 (2008).

In an embodiment of the presently claimed invention, the at least one C₆-C₂₄ monocarboxylic acid in embodiment 1 is selected from the group consisting of caproic acid, caprylic acid, capric acid, lauric acid, myristic acid, palmitic acid, stearic acid, oleic acid and behenic acid. In an embodiment of the presently claimed invention, the at least one C₆-C₂₄ monocarboxylic acid in embodiment 1 is selected from the group consisting of myristic acid, palmitic acid, stearic acid, oleic acid and behenic acid.

In an embodiment of the presently claimed invention, the at least one ester in the composition in the embodiment 1 can be obtained by the general reaction methods of esterification known in the prior art. In an embodiment of the presently claimed invention, the degree of esterification of the at least one ester in the composition in the embodiment 1 is in the range between 60% to 100%. In another embodiment of the presently claimed invention, the degree of esterification of the at least one ester in the composition in the embodiment 1 is in the range between 80% to 95%. In yet another embodiment of the presently claimed invention, the degree of esterification of the at least one ester in the composition in the embodiment 1 is in the range between 88% to 95% .In another embodiment of the presently claimed invention, the at least one ester in the embodiment 1 can be obtained by reacting at least one compound having 2 to 12 hydroxy groups and at least one C₆-C₂₄ monocarboxylic acid in the presence of a catalyst. Suitable catalysts include, but are not limited to methane sulfonic acid, sulfuric acid, para-toluenesulfonic acid, sodium hydroxide and phosphoric acid. The molar ratio of hydroxy group to the acid group is in the range of 1:1.

In an embodiment of the presently claimed invention, the at least one first styrene acrylic copolymer in embodiment 1 is present in an amount in the range of 20 wt.% to 60 wt.%, based on the total weight of the coating composition. In another embodiment of the presently claimed invention, the at least one first styrene acrylic copolymer in embodiment 1 is present in an amount in the range of 25 wt.% to 60 wt.%, in another embodiment, in a range of 30 wt.% to 60 wt.%, or in a range of 20 wt.% to 55 wt.%, or in a range of 20 wt.% to 50 wt.%, or in a range of 35 wt.% to 60 wt.%, or in a range of 40 wt.% to 60 wt.%, or in a range of 25 wt.% to 55 wt.%, or in a range of 30 wt.% to 55 wt.%, or in a range of 25 wt.% to 50 wt.%, or in a range of 25 wt.% to 45 wt.%, in each case based on the total weight of the coating composition.

In an embodiment of the presently claimed invention, the at least one first styrene acrylic copolymer in embodiment 1 has a glass transition temperature in the range of from -35° C. to 5° C., measured by differential scanning calorimetry according to ASTM D 7426 (2013). In another embodiment of the presently claimed invention, the at least one first styrene acrylic copolymer in embodiment 1 has a glass transition temperature in the range of from -30° C. to 5° C., in another embodiment, in the range of from -25° C. to 5° C., or in the range of from -20° C. to 5° C., or in the range of from -15° C. to 5° C., or in the range of from -30° C. to 0° C., or in the range of from -30° C. to -5° C., or in the range of from -25° C. to -5° C., or in the range of from -25° C. to -10° C., in each case measured by differential scanning calorimetry according to ASTM D 7426 (2013).

In an embodiment of the presently claimed invention, the at least one first styrene acrylic copolymer in embodiment 1 has a weight average molecular weight in the range of 1000 g/mol to 25,000 g/mol, measured by gel permeation chromatography according to ISO 13885-1 (2008). In another embodiment of the presently claimed invention, the at least one first styrene acrylic copolymer in embodiment 1 has a weight average molecular weight in the range of 2000 g/mol to 25,000 g/mol, in another embodiment, in the range of 2000 g/mol to 20,000 g/mol, or in the range of 3000 g/mol to 20,000 g/mol, or in the range of 3000 g/mol to 15,000 g/mol, or in the range of 4000 g/mol to 15,000 g/mol, or in the range of 5000 g/mol to 15,000 g/mol, in each case measured by gel permeation chromatography according to ISO 13885-1 (2008).

In an embodiment of the presently claimed invention, the at least one first styrene acrylic copolymer in embodiment 1 is obtained by polymerization of at least one (meth)acrylic monomer selected from the group consisting of acrylic acid, methacrylic acid, methylmethacrylic acid, methyl acrylate, methyl methacrylate, ethyl acrylate, ethyl methacrylate, a hydroxy vinyl ether, n-propyl acrylate, isopropyl acrylate, n-butyl acrylate, n-butyl methacrylate, isobutyl acrylate, isobutyl methacrylate, 2-ethylhexyl acrylate,2-ethylhexyl methacrylate, n-decyl acrylate, n-amyl acrylate, n-hexyl acrylate, isoamyl acrylate, 2-hydroxyethyl acrylate, 2-hydroxypropyl acrylate, N,N-dimethylaminoethyl acrylate, N,N-diethylaminoethyl acrylate, t-butylaminoethyl acrylate, 2-sulfoethyl acrylate, trifluorethyl acrylate, glycidyl acrylate, benzyl acrylate, allyl acrylate, 2-n-butoxyethyl acrylate, 2-chloroethyl acrylate, sec-butyl acrylate, tert-butyl acrylate, 2-ethylbutyl acrylate, cinnamyl acrylate, crotyl acrylate, cyclohexyl acrylate, cyclopentyl acrylate, 2-ethoxyethyl acrylate, furfuryl acrylate, hexafluoroisopropoyl acrylate, methallyl acrylate, 2-n-butoxyethyl methacrylate, 2-chloroethyl methacrylate, sec-butyl-methacrylate, tert-butyl methacrylate, 2-ethylbutyl methacrylate, cinnamyl methacrylate, crotyl methacrylate, cyclohexyl methacrylate, cyclopentyl methacrylate, 2-ethoxyethyl methacrylate, furfuryl methacrylate, hexafluoroisopropyl methacrylate, methallyl methacrylate, 3-methoxybutyl methacrylate, 2-methoxybutyl methacrylate, 2-nitro-2-methylpropyl methacrylate, n-octylmethacrylate, 2-ethylhexyl methacrylate, 2-phenoxyethyl methacrylate, 2-phenylethyl methacrylate, phenyl methacrylate, propargyl methacrylate, tetrahydrofurfuryl methacrylate, tetrahydropyranyl methacrylate, hydroxyalkyl acrylates and methacrylates, acrylic acid and its salts, acrylonitrile, acrylamide, methyl chloroacrylate, methyl 2-cyanoacrylate, N-ethylacrylamide, N,N-diethylacrylamide, acrolein, methacrylic acid and its salts, methacrylonitrile, methacrylamide, N-methylmethacrylamide, N-ethylmethacrylamide, N,N-diethylmethacrylamide, N,N-dimethylmethacrylamide, N-phenylmethacrylamide, methacrolein, or a mixture thereof and at least one styrene monomer.

Exemplary (meth)acrylic acid monomers include, but are not limited to, methyl acrylate, methyl methacrylate, ethyl acrylate, ethyl methacrylate, butyl acrylate, butyl methacrylate, 2-ethylhexyl acrylate, 2-ethylhexyl methacrylate, isobutyl (meth)acrylate, n-hexyl (meth)acrylate, n-heptyl (meth)acrylate, 2-methylheptyl (meth)acrylate, octyl (meth)acrylate, isooctyl (meth)acrylate, n-nonyl (meth)acrylate, isononyl (meth)acrylate, n-decyl (meth)acrylate, isodecyl (meth)acrylate, dodecyl (meth)acrylate, lauryl (meth)acrylate, tridecyl (meth)acrylate, stearyl (meth)acrylate, glycidyl (meth)acrylate, alkyl crotonates, vinyl acetate, di-n-butyl maleate, di-octylmaleate, hydroxyethyl (meth)acrylate, allyl (meth)acrylate, tetrahydrofurfuryl (meth)acrylate, cyclohexyl (meth)acrylate, 2-ethoxyethyl (meth)acrylate, 2-methoxy (meth)acrylate, 2-(2-ethoxyethoxy)ethyl (meth)acrylate, 2-propylheptyl (meth)acrylate, 2-phenoxyethyl (meth)acrylate, isobornyl (meth)acrylate, caprolactone (meth)acrylate, polypropyleneglycol mono(meth)acrylate, polyethyleneglycol (meth)acrylate, benzyl (meth)acrylate, hydroxypropyl (meth)acrylate, methylpolyglycol (meth)acrylate, 3,4-epoxycyclohexylmethyl (meth)acrylate, 1,6 hexanediol di(meth)acrylate, 1,4 butanediol di(meth)acrylate, and combinations thereof..

Suitable styrene monomers are selected from the group consisting of styrene, 1,3-dimethylstyrene, chlorostyrene, bromostyrene, α- methylstyrene, m-methylstyrene, p-methylstyrene, α-butylstyrene, 4-n-butylstyrene, 4-n-decylstyrene and mixtures thereof.

In another embodiment of the presently claimed invention, the at least one first styrene acrylic copolymer in embodiment 1 is obtained by polymerization of at least one (meth)acrylic monomer selected from the group consisting of acrylic acid, methacrylic acid, methylmethacrylic acid, methyl acrylate, methyl methacrylate, ethyl acrylate, ethyl methacrylate, a hydroxy vinyl ether, n-propyl acrylate, isopropyl acrylate, n-butyl acrylate, n-butyl methacrylate, isobutyl acrylate, isobutyl methacrylate, 2-ethylhexyl acrylate,2-ethylhexyl methacrylate, 2-n-butoxyethyl acrylate, 2-chloroethyl acrylate, sec-butyl acrylate, tert-butyl acrylate, 2-ethylbutyl acrylate, 2-ethoxyethyl acrylate, 2-chloroethyl methacrylate, sec-butyl-methacrylate, tert-butyl methacrylate, 2-ethylbutyl methacrylate, or a mixture thereof and at least one styrene monomer.

In another embodiment of the presently claimed invention, the at least one first styrene acrylic copolymer in embodiment 1 is obtained by polymerization of at least one (meth)acrylic monomer selected from the group consisting of acrylic acid, methacrylic acid, methylmethacrylic acid, methyl acrylate, methyl methacrylate, ethyl acrylate, ethyl methacrylate, n-butyl acrylate, n-butyl methacrylate, isobutyl acrylate, isobutyl methacrylate, 2-ethylhexyl acrylate,2-ethylhexyl methacrylate, or a mixture thereof and at least one styrene monomer.

In another embodiment of the presently claimed invention, the at least one first styrene acrylic copolymer in embodiment 1 is obtained by polymerization of at least one (meth)acrylic monomer selected from the group consisting of n-butyl acrylate, n-butyl methacrylate, isobutyl acrylate, isobutyl methacrylate, 2-ethylhexyl acrylate,2-ethylhexyl methacrylate, or a mixture thereof and at least one styrene monomer.

In an embodiment of the presently claimed invention, the at least one first styrene acrylic copolymer in embodiment 1 obtained by polymerization of at least one (meth) acrylic acid monomer and at least one styrene monomer, wherein the at least one (meth) acrylic acid monomer is present in polymerized form in an amount in the range of 10 wt.% to 70 wt.%, based on the total weight of at least one first styrene acrylic copolymer. In another an embodiment of the presently claimed invention, the at least one first styrene acrylic copolymer in embodiment 1 obtained by polymerization of at least one (meth) acrylic acid monomer and at least one styrene monomer, wherein the at least one (meth) acrylic acid monomer is present in polymerized form in an amount in the range 15 wt.% to 65 wt.%, in another embodiment, in the range of 15 wt.% to 60 wt.%, or in the range of 15 wt.% to 55 wt.%, or in the range of 10 wt.% to 60 wt.%, or in the range of 10 wt.% to 55 wt.%, or in the range of 10 wt.% to 50 wt.%, or in the range of 15 wt.% to 50 wt.%, or in the range of 10 wt.% to 45 wt.%, or in the range of 15 wt.% to 45 wt.%, or in the range of 10 wt.% to 40 wt.%, or in the range of 15 wt.% to 40 wt.%, in each case based on the total weight of at least one first styrene acrylic copolymer.

In an embodiment of the presently claimed invention, the at least one first styrene acrylic copolymer in embodiment 1 obtained by polymerization of at least one (meth) acrylic acid monomer and at least one styrene monomer, wherein the at least styrene monomer is present in polymerized form in an amount in the range of 20 wt.% to 65 wt.%, based on the total weight of at least one first styrene acrylic copolymer. In another an embodiment of the presently claimed invention, the at least one first styrene acrylic copolymer in embodiment 1 obtained by polymerization of at least one (meth) acrylic acid monomer and at least one styrene monomer, wherein the at least one styrene monomer is present in polymerized form in an amount in the range 25 wt.% to 65 wt.%, in another embodiment, in the range of 20 wt.% to 60 wt.%, or in the range of 25 wt.% to 60 wt.%, or in the range of 25 wt.% to 55 wt.%, or in the range of 20 wt.% to 55 wt.%, or in the range of 20 wt.% to 50 wt.%, or in the range of 25 wt.% to 50 wt.%, or in the range of 30 wt.% to 65 wt.%, or in the range of 30 wt.% to 60 wt.%, or in the range of 35 wt.% to 55 wt.%, in each case based on the total weight of at least one first styrene acrylic copolymer.

In an embodiment of the presently claimed invention, the composition in embodiment 1 further comprises a second styrene acrylic copolymer.

In another embodiment of the presently claimed invention, the composition in embodiment 1 further comprises a second styrene acrylic copolymer, wherein the second styrene acrylic copolymer has a glass transition temperature in the range of from 60° C. to 150° C., measured by differential scanning calorimetry according to ASTM D 7426 (2013). In another embodiment of the presently claimed invention, the composition in embodiment 1 further comprising a second styrene acrylic copolymer has a glass transition temperature in the range of from 60° C. to 145° C., in another embodiment, in the range of from 62° C. to 140° C., or in the range of from 64° C. to 130° C., or, in the range of from 65° C. to 145° C., or in the range of from 65° C. to 145° C., or in the range of from 68° C. to 140° C., or in the range of from 65° C. to 120° C., or in the range of from 60° C. to 140° C., or in the range of from 65° C. to 140° C., or in the range of from 70° C. to 150° C., or in the range of from 70° C. to 145° C., or in the range of from 70° C. to 140° C., or in the range of from 75° C. to 140° C., or in the range of from 75° C. to 135° C., or in the range of from 80° C. to 150° C., or in the range of from 80° C. to 145° C., or in the range of from 80° C. to 140° C., or in the range of from 60° C. to 135° C., or in the range of from 60° C. to 130° C., or in the range of from 60° C. to 125° C., or in the range of from 60° C. to 120° C., or in the range of from 60° C. to 115° C., or in the range of from 60° C. to 110° C., or in the range of from 60° C. to 100° C., or in the range of from 60° C. to 95° C., in each case measured by differential scanning calorimetry according to ASTM D 7426 (2013).

In an embodiment of the presently claimed invention, the composition in embodiment 1 further comprising a second styrene acrylic copolymer in polymerized form is present in an amount in the range of 10 wt.% to 40 wt.%, based on the total weight of the coating composition. In another embodiment of the presently claimed invention, the composition in embodiment 1 further comprising a second styrene acrylic copolymer in polymerized form is present in an amount in the range of 10 wt.% to 35 wt.%, in another embodiment, in the range of 10 wt.% to 30 wt.%, or the range of 10 wt.% to 25 wt.%, or in the range of 15 wt.% to 40 wt.%, or in the range of 15 wt.% to 35 wt.%, or in the range of 15 wt.% to 30 wt.%, or in the range of 20 wt.% to 40 wt.%, in each case based on the total weight of the coating composition.

In an embodiment of the presently claimed invention, the composition in embodiment 1 further comprising a second styrene acrylic copolymer has a weight average molecular weight in the range of 1000 g/mol to 15,000 g/mol, measured by gel permeation chromatography according to ISO 13885-1 (2008). In an embodiment of the presently claimed invention, the composition in embodiment 1 further comprising a second styrene acrylic copolymer has a weight average molecular weight in the range of 1000 g/mol to 10,000 g/mol, in another embodiment, in the range of 2000 g/mol to 15,000 g/mol, or in the range of 3000 g/mol to 15,000 g/mol, or in the range of 4000 g/mol to 15,000 g/mol, or in the range of 5000 g/mol to 15,000 g/mol, or in the range of 5000 g/mol to 10,000 g/mol, or in the range of 6000 g/mol to 15,000 g/mol, or in the range of 7000 g/mol to 15,000 g/mol, or in the range of 8000 g/mol to 15,000 g/mol, in each case measured by gel permeation chromatography according to ISO 13885-1(2008).

In an embodiment of the presently claimed invention, the composition in embodiment 1 further comprising a second styrene acrylic copolymer is obtained by polymerization of at least (meth)acrylic monomer selected from the group consisting of acrylic acid, methacrylic acid, methylmethacrylic acid, methyl acrylate, methyl methacrylate, ethyl acrylate, ethyl methacrylate, a hydroxy vinyl ether, n-propyl acrylate, isopropyl acrylate, n-butyl acrylate, n-butyl methacrylate, isobutyl acrylate, isobutyl methacrylate, 2-ethylhexyl acrylate,2-ethylhexyl methacrylate, n-decyl acrylate, n-amyl acrylate, n-hexyl acrylate, isoamyl acrylate, 2-hydroxyethyl acrylate, 2-hydroxypropyl acrylate, N,N-dimethylaminoethyl acrylate, N,N-diethylaminoethyl acrylate, t-butylaminoethyl acrylate, 2-sulfoethyl acrylate, trifluorethyl acrylate, glycidyl acrylate, benzyl acrylate, allyl acrylate, 2-n-butoxyethyl acrylate, 2-chloroethyl acrylate, sec-butyl acrylate, tert-butyl acrylate, 2-ethylbutyl acrylate, cinnamyl acrylate, crotyl acrylate, cyclohexyl acrylate, cyclopentyl acrylate, 2-ethoxyethyl acrylate, furfuryl acrylate, hexafluoroisopropoyl acrylate, methallyl acrylate, 2-n-butoxyethyl methacrylate, 2-chloroethyl methacrylate, sec-butyl-methacrylate, tert-butyl methacrylate, 2-ethylbutyl methacrylate, cinnamyl methacrylate, crotyl methacrylate, cyclohexyl methacrylate, cyclopentyl methacrylate, 2-ethoxyethyl methacrylate, furfuryl methacrylate, hexafluoroisopropyl methacrylate, methallyl methacrylate, 3-methoxybutyl methacrylate, 2-methoxybutyl methacrylate, 2-nitro-2-methylpropyl methacrylate, n-octylmethacrylate, 2-ethylhexyl methacrylate, 2-phenoxyethyl methacrylate, 2-phenylethyl methacrylate, phenyl methacrylate, propargyl methacrylate, tetrahydrofurfuryl methacrylate, tetrahydropyranyl methacrylate, hydroxyalkyl acrylates and methacrylates, acrylic acid and its salts, acrylonitrile, acrylamide, methyl chloroacrylate, methyl 2-cyanoacrylate, N-ethylacrylamide, N,N-diethylacrylamide, acrolein, methacrylic acid and its salts, methacrylonitrile, methacrylamide, N-methylmethacrylamide, N-ethylmethacrylamide, N,N-diethylmethacrylamide, N,N-dimethylmethacrylamide, N-phenylmethacrylamide, methacrolein, or a mixture thereof and at least one styrene monomer.

Exemplary (meth) acrylic acid monomers include, but are not limited to, methyl acrylate, methyl methacrylate, ethyl acrylate, ethyl methacrylate, butyl acrylate, butyl methacrylate, 2-ethylhexyl acrylate, 2-ethylhexyl methacrylate, isobutyl (meth)acrylate, n-hexyl (meth)acrylate, n-heptyl (meth)acrylate, 2-methylheptyl (meth)acrylate, octyl (meth)acrylate, isooctyl (meth)acrylate, n-nonyl (meth)acrylate, isononyl (meth)acrylate, n-decyl (meth)acrylate, isodecyl (meth)acrylate, dodecyl (meth)acrylate, lauryl (meth)acrylate, tridecyl (meth)acrylate, stearyl (meth)acrylate, glycidyl (meth)acrylate, alkyl crotonates, vinyl acetate, di-n-butyl maleate, di-octylmaleate, hydroxyethyl (meth)acrylate, allyl (meth)acrylate, tetrahydrofurfuryl (meth)acrylate, cyclohexyl (meth)acrylate, 2-ethoxyethyl (meth)acrylate, 2-methoxy (meth)acrylate, 2-(2-ethoxyethoxy)ethyl (meth)acrylate, 2-propylheptyl (meth)acrylate, 2-phenoxyethyl (meth)acrylate, isobornyl (meth)acrylate, caprolactone (meth)acrylate, polypropyleneglycol mono(meth)acrylate, polyethyleneglycol (meth)acrylate, benzyl (meth)acrylate, hydroxypropyl (meth)acrylate, methylpolyglycol (meth)acrylate, 3,4-epoxycyclohexylmethyl (meth)acrylate, 1,6 hexanediol di(meth)acrylate, 1,4 butanediol di(meth)acrylate, and combinations thereof..

Suitable styrene monomers are selected from the group consisting of styrene, 1,3-dimethylstyrene, chlorostyrene, bromostyrene, α- methylstyrene, m-methylstyrene, p-methylstyrene, α-butylstyrene, 4-n-butylstyrene, 4-n-decylstyrene and mixtures thereof.

In another embodiment of the presently claimed invention, the composition in embodiment 1 further comprising a second styrene acrylic copolymer is obtained by polymerization of at least one (meth)acrylic monomer selected from the group consisting of acrylic acid, methacrylic acid, methylmethacrylic acid, methyl acrylate, methyl methacrylate, ethyl acrylate, ethyl methacrylate, a hydroxy vinyl ether, n-propyl acrylate, isopropyl acrylate, n-butyl acrylate, n-butyl methacrylate, isobutyl acrylate, isobutyl methacrylate, 2-ethylhexyl acrylate,2-ethylhexyl methacrylate, 2-n-butoxyethyl acrylate, 2-chloroethyl acrylate, sec-butyl acrylate, tert-butyl acrylate, 2-ethylbutyl acrylate, 2-ethoxyethyl acrylate, 2-chloroethyl methacrylate, sec-butyl-methacrylate, tert-butyl methacrylate, 2-ethylbutyl methacrylate, or a mixture thereof and at least one styrene monomer.

In another embodiment of the presently claimed invention, the composition in embodiment 1 further comprising a second styrene acrylic copolymer is obtained by polymerization of at least one (meth)acrylic monomer selected from the group consisting of acrylic acid, methacrylic acid, methylmethacrylic acid, methyl acrylate, methyl methacrylate, ethyl acrylate, ethyl methacrylate, or a mixture thereof and at least one styrene monomer.

In another embodiment of the presently claimed invention, the composition in embodiment 1 further comprising a second styrene acrylic copolymer is obtained by polymerization of at least one (meth)acrylic monomer selected from the group consisting of methylmethacrylic acid, methyl acrylate, methyl methacrylate, or a mixture thereof and at least one styrene monomer.

In another embodiment of the presently claimed invention, the composition in embodiment 1 further comprising a second styrene acrylic copolymer obtained by polymerization of at least one (meth) acrylic acid monomer and at least one styrene monomer, wherein the at least one (meth) acrylic acid monomer in polymerized form is present in an amount in the range of 10 wt.% to 60 wt.%, based on the total weight of at least one second styrene acrylic copolymer. In a yet another embodiment of the presently claimed invention, the composition in embodiment 1 further comprising a second styrene acrylic copolymer obtained by polymerization of at least one (meth) acrylic acid monomer and at least one styrene monomer, wherein the at least one (meth) acrylic acid monomer in polymerized form is present in an amount in the range of 15 wt.% to 60 wt.%, in another embodiment, in the range of 15 wt.% to 55 wt.%, or in the range of 15 wt.% to 50 wt.%, or in the range of 10 wt.% to 65 wt.%, or in the range of 10 wt.% to 60 wt.%, or in the range of 10 wt.% to 55 wt.%, in the range of 15 wt.% to 60 wt.%, or in the range of 15 wt.% to 55 wt.%, or in the range of 15 wt.% to 50 wt.%, or in the range of 15 wt.% to 45 wt.%, or in the range of 10 wt.% to 50 wt.%, or in the range of 10 wt.% to 45 wt.%, in each case based on the total weight of at least one second styrene acrylic copolymer.

In another embodiment of the presently claimed invention, the composition in embodiment 1 further comprising a second styrene acrylic copolymer obtained by polymerization of at least one (meth) acrylic acid monomer and at least one styrene monomer, wherein the at least one styrene monomer is present in an amount in the range of 20 wt.% to 85 wt.%, based on the total weight of at least one second styrene acrylic copolymer. In a yet another embodiment of the presently claimed invention, the composition in embodiment 1 further comprising a second styrene acrylic copolymer obtained by polymerization of at least one (meth) acrylic acid monomer and at least one styrene monomer, wherein the at least one styrene monomer is present in an amount in the range of 25 wt.% to 85 wt.%, in another embodiment, in the range of 30 wt.% to 85 wt.%, or in the range of 35 wt.% to 85 wt.%, or in the range of 40 wt.% to 85 wt.%, or in the range of 45 wt.% to 85 wt.%, or in the range of 50 wt.% to 85 wt.%, in each case based on the total weight of at least one second styrene acrylic copolymer.

In an embodiment of the presently claimed invention, the composition in embodiment 1 further comprises at least one rheology modifier.

In another embodiment of the presently claimed invention, the composition in embodiment 1 further comprises at least one rheology modifier, wherein the at least one rheology modifier is selected from the group consisting of modified high-density polyethylene, metallocene polyethylene wax and modified hydrogenated castor oil. In a yet another embodiment of the presently claimed invention, the composition in embodiment 1 further comprises at least one rheology modifier, wherein the at least one rheology modifier is selected from the group consisting of modified high-density polyethylene and metallocene polyethylene wax.

In another embodiment of the presently claimed invention, the composition in embodiment 1 further comprises at least one rheology modifier, wherein the at least one rheology modifier is present in an amount in the range of 0.5 wt.% to 4.0 wt.%, based on the total weight of the coating composition. In a yet another embodiment of the presently claimed invention, the composition in embodiment 1 further comprises at least one rheology modifier, wherein the at least one rheology modifier is present in an amount in the range of 0.5 wt.% to 3.5 wt.%, in another embodiment, in the range of 0.6 wt.% to 4.0 wt.%, or in the range of 0.7 wt.% to 4.0 wt.%, or in the range of 0.8 wt.% to 4.0 wt.%, in the range of 0.9 wt.% to 4.0 wt.%, or in the range of 0.5 wt.% to 3.0 wt.%, or in the range of 1.0 wt.% to 4.0 wt.%, 1.0 wt.% to 3.5 wt.%, or 1.0 wt.% to 3.0 wt.%, in each based on the total weight of the coating composition.

In another embodiment of the presently claimed invention, the composition in embodiment 1 further comprises at least one anti-blocking agent.

In another embodiment of the presently claimed invention, the composition in embodiment 1 further comprises at least one anti-blocking agent, wherein the at least one anti-blocking agent is selected from the group consisting of talc, aluminum oxide powder, silica and fatty amides. In a yet another embodiment of the presently claimed invention, the composition in embodiment 1 further comprises at least one anti-blocking agent, wherein the at least one anti-blocking agent is selected from fatty amides.

In another embodiment of the presently claimed invention, the composition in embodiment 1 further comprises at least one anti-blocking agent, wherein the at least one anti-blocking agent is present in an amount in the range of 0.5 wt.% to 3 wt.%, based on the total weight of the coating composition. In a yet another embodiment of the presently claimed invention, the composition in embodiment 1 further comprises at least one anti-blocking agent, wherein the at least one anti-blocking agent is present in an amount in the range of 0.5 wt.% to 2.5 wt.%, in another embodiment, in the range of 1.0 wt.% to 3.0 wt.%, or in the range of 0.6 wt.% to 3.0 wt.%, or in the range of 0.7 wt.% to 3.0 wt.%, or in the range of 0.8 wt.% to 3.0 wt.%, or in the range of 0.9 wt.% to 3.0 wt.%, or in the range of 0.5 wt.% to 2.0 wt.%, or in the range of 1.0 wt.% to 2.5 wt.%, in each case based on the total weight of the coating composition.

Another aspect of the present invention is embodiment 2, directed towards a process for preparing the composition according to embodiment 1, comprising at least the steps of:
(i) mixing of at least one ester and at least one first styrene acrylic copolymer to form a mixture;
(ii) heating the mixture to a temperature in the range of from 90° C. to 140° C. ; and

wherein the at least one ester is obtained by reacting at least one compound having 2 to 12 hydroxy groups and at least one C₆-C₂₄ monocarboxylic acid.

In an embodiment of the presently claimed invention, the process in embodiment 2 can be carried out batchwise, semi-continuously or continuously.

In an embodiment of the presently claimed invention, the heating of the mixture in the process in embodiment 2 is carried out at a temperature in the range of 100° C. to 140° C.

In another embodiment of the presently claimed invention, the at least one ester in the process in embodiment 2 is selected from the group consisting of pentaerythritol tetrastearate, pentaerythritol oleate, pentaerythritol tetrabehenate, pentaerythritol tetraisopalmitate, glyceryl tristearate, erythritol distearate, sorbitan stearate and dipentaerythritol stearate. In a yet another embodiment of the presently claimed invention, at least one first styrene acrylic copolymer in embodiment 2 has a glass transition temperature in the range of from - 54° C. to 10° C., measured by differential scanning calorimetry according to ASTM D 7426 (2013).

In an embodiment of the presently claimed invention, the at least one compound having 2 to 12 hydroxy groups in embodiment 2 is selected from the group consisting of ethylene glycol, glycerol, erythritol, pentaerythritol, mesoerythritol, 1,2,6-hexanetriol, sorbitol, trimethylolpropane, 1,2,4-butanetriol, trimethylolethane, arabitol, xylitol, mannitol, dipentaerythritol, monosaccharides, disaccharides and polysaccharides.

In an embodiment of the presently claimed invention, the at least one C₆-C₂₄ monocarboxylic acid in embodiment 2 is selected from the group consisting of caproic acid, caprylic acid, capric acid, lauric acid, myristic acid, palmitic acid, stearic acid, oleic acid and behenic acid,

Another aspect of the present invention is embodiment 3 is directed towards a coating comprising the composition according to embodiment 1.

Another aspect of the present invention is embodiment 4 is directed towards a substrate coated on at least one surface with the coating according to embodiment 3.

The compositions disclosed herein can be used with any substrate to impart water or moisture resistance, block resistance and viscosity. In an embodiment of the presently claimed invention, the substrate according to embodiment 4 can be a cellulose-based substrate, such as paper, paper board, or cardboard. The cellulose-based substrates can include paper cups, including for instance, paper cups, paper bags for dry foods, such as, for example, coffee, tea, soup powders, sauce powders; for liquids, such as, for example, cosmetics, cleaning agents, beverages; of tube laminates; of paper carrier bags; of paper laminates and co-extrudates for ice cream, confectionery (e.g., chocolate bars and muesli bars), of paper adhesive tape; of cardboard cups (e.g., paper cups), yogurt pots, souffle cups; of meal trays, or meat trays; of wound cardboard containers (e.g., cans, drums), of wet-strength cartons for outer packaging (e.g., wine bottles, food); of fruit boxes of coated cardboard; of fast food plates; of clamp shells; of beverage cartons and cartons for liquids, such as detergents and cleaning agents, frozen food cartons, ice packaging (e.g., ice cups, wrapping material for conical ice cream wafers); of paper labels; or of flower pots and plant pots.

In an embodiment of the presently claimed invention, a substrate coated according to embodiment 4 can be coated on one or more surfaces of the substrate. For purposes of the presently claimed invention, the substrate also refers to paper cups or paper bags. The paper cup can have an interior surface, an exterior surface, a bottom portion, and a side portion. The aqueous composition can be on a first surface and/or a second surface of the paper cup. The first surface may comprise one or more of an interior surface of the side portion and/or an interior surface of the bottom portion. In some embodiments, only a portion, for e.g., 10% or greater, 20% or greater, 30% or greater, 40% or greater, 50% or greater, 60% or greater, 70% or greater, 80% or greater, 90% or greater, or all of the interior surface is coated. In an embodiment of the presently claimed invention, the entire interior surface is coated. In an embodiment of the presently claimed invention, the second surface, comprises one or more of an exterior surface of the side portion and/or an exterior surface of the bottom portion. In another embodiment of the presently claimed invention, only a portion, for e.g., 10% or greater, 20% or greater, 30% or greater, 40% or greater, 50% or greater, 60% or greater, 70% or greater, 80% or greater, 90% or greater, or all of the exterior surface is coated. In yet another embodiment of the presently claimed invention, the entire exterior surface is coated.

In an embodiment of the presently claimed invention, the substrate according to embodiment 4 is provided coating throughout the substrate, for example, a paper web formed of cellulosic fibers. In yet another embodiment of the presently claimed invention, the coating can be from 4 wt.% to 50 wt.% by weight of the substrate, for e.g., from 5 wt.% to 50 wt.%, from 5 wt.% to 45 wt.%, from 5 wt.% to 40 wt.%, from 5 wt.% to 35 wt.%, from 5 wt.% to 30 wt.%, from 5 wt.% to 25 wt.%, in each case based on the weight of the substrate.

In an embodiment of the presently claimed invention, the substrate according to embodiment 4 is selected from the group consisting of coated paper, uncoated paper and paperboard.

Yet another aspect of the present invention is embodiment 5 is directed towards a paper stock comprising a substrate coated with the coating according to embodiment 3.

In an embodiment of the presently claimed invention, the substrate coated with the coating according to embodiment 3 has a coating weight in the range of from 20 g to 50 g. In another embodiment of presently claimed invention, the substrate coated with the coating according to embodiment 3 has a coating weight in the range of from 20 g to 45 g, in another embodiment, in the range of from 20 g to 40 g, or in the range of from 25 g to 50 g, from 30 g to 50 g.

Further, the substrate coated according to embodiment 4 described herein may exhibit minimal tendencies of blocking, i.e., the adhesion of the coated surface to another coated surface, or the adhesion of the coated surface to an uncoated surface of the extrusion coated paper when wound onto paper rolls, before cutting/forming into finished paper products. Blocking resistance can be tested using the I.C. Block tester, described by ASTM D4946-89. For purposes of the presently claimed invention, sufficient block resistance refers to a rating of 3 or above according to the rating system described in the instant Examples. For purposes of the presently claimed invention, presence of substrate damage is assessed by the naked eye. For purposes of the presently claimed invention, “no substrate damage” refers to no substrate damage as observed by the naked eye.

In another embodiment of the presently claimed invention, the substrate coated according to embodiment 4 has a block resistance of 3 or more for 4 hours at 20 lb_{f} (89 N) and 50° C., determined according to method disclosed in the experimental section. In another embodiment of the presently claimed invention, the substrate coated according to embodiment 4 has a block resistance of 4 or more for 4 hours at 20 lb_{f} (89 N) and 50° C., determined according to method disclosed in the experimental section.

Liquid-water and water-vapor resistance of a substrate comprising the coating according to embodiment 4 can be tested with the Cobb method, described by TAPPI T 441 (2001). In an embodiment of the presently claimed invention, the substrate coated according to embodiment 4 described herein would pass the water-resistance test set forth in this test method. Water absorptiveness can be a function of various characteristics of paper or paperboard including, but are not limited to, sizing and porosity.

In an embodiment of the presently claimed invention, the substrate coated according to embodiment 4 can exhibit a Cobb value less than 10, determined according to TAPPI T 441.

Slide Angle of a substrate comprising the coating according to embodiment 4 can be tested with the Slide Angle determination method, described by TAPPI T 815. The slide angle testing uses a 4 lb sled and a motorized track to determine at what angle two coating surfaces will slide past one another. In an embodiment of the presently claimed invention, the substrate coated according to embodiment 4 can exhibit a slide angle value of 20 to 30 degrees, determine according to TAPPI T 815.

In an embodiment of the presently claimed invention, the fiber yield on repulpability testing of the substrate coated according to embodiment 4 is in the range of 95% to 99%, determined according to the method disclosed in the Examples.

In an embodiment of the presently claimed invention, the composition in the embodiment 1 or a coating comprising the composition as per embodiment 3 is provided as a coating to provide block resistance and water resistance. In another embodiment of the presently claimed invention, a substrate that is coated according to embodiment 4 exhibits improved properties such as block resistance, water resistance and melt viscosity. For purposes of the presently claimed invention, the substrate includes but is not limited to paper and paper products.

In another embodiment of the presently claimed invention, a substrate that is coated with the coating according to embodiment 3 or composition as per embodiment 1 is repulpable.

In another embodiment of the presently claimed invention, a substrate that is coated with the coating according to embodiment 3 or composition as per embodiment 1 is recyclable and repulpable.

For the purposes of the presently claimed invention, the coating can be applied to a surface of a substrate such as the paper by any suitable coating technique known in the art, including spraying, rolling, brushing, with curtain coater, slot-die coater, roll coater or spreading. Coating can be applied in a single coat, or in multiple sequential coats (e.g., in two coats or in three coats) as required for a particular application. Generally, the coating is allowed to dry under ambient conditions.

The first and second styrene acrylic copolymer described above can be prepared by continuous high temperature bulk polymerization techniques. For example, the styrene acrylic copolymer may be made by a continuous polymerization process that includes charging into a reactor a mixture including vinylic monomers, and a polymerization initiator. The reactor is then maintained at a temperature of from 150° C. to 300° C. for a time period sufficient to oligomerize the monomers. A styrene acrylic copolymer containing vinylic unsaturation is then isolated, and is then hydrogenated to form a styrene acrylic copolymer having an insubstantial amount of olefinic unsaturation. As used herein, an “insubstantial amount of olefinic unsaturation” means that the styrene acrylic oligomer is essentially free of olefinic unsaturation in the resin, except for possibly a small amount. In some embodiments, the insubstantial amount of olefinic unsaturation is measured by IR or NMR spectroscopic techniques. In one embodiment, the polymerization temperatures range from 150° C. to 180° C., this includes embodiments where the temperatures range from 180° C. to 220° C., from 220° C. to 280° C., and from 250° C. to 300° C.

In some embodiments, the hydrogenating includes contacting the styrene acrylic copolymer with hydrogen and a hydrogenation catalyst.

In some embodiments, hydrogenation catalysts include those that are known to effect hydrogenation of an unsaturated molecule. For example, such catalysts may include those of palladium, platinum, nickel, rhodium, iridium, and the like. In some embodiments, the hydrogenation catalyst includes palladium, platinum, or nickel. In some such embodiments, the hydrogenation catalyst may be palladium on carbon, platinum on carbon, or Raney nickel.

Suitable vinylic monomers for use in the methods include, but are not limited to monoalkenyl aromatic monomers, (meth)acrylic monomers, ethylenic monomers, hydroxyalkyl acrylates, hydroxyalkyl methacrylates, and ethylenic monomers. In some embodiments, the vinylic monomers are styrenic monomers such as styrene or methylstyrene, or a (meth)acrylic monomer, or a mixture thereof. In some embodiments, the vinylic monomers include 40 to 65 wt.% of the monoalkenyl aromatic monomers; and from 35 to 60 wt.% (meth)acrylic monomers. In some embodiments, the (meth)acrylic monomer includes, but is not limited to, ethyl acrylate, methyl (meth)acrylate, butyl (meth)acrylate, 2-ethylhexyl (meth)acrylate, hydroxyethyl (meth)acrylate, glycidyl (meth)acrylate, or acrylic acid. In some embodiments, the (meth)acrylic monomer includes glycidyl (meth)acrylate. In some embodiments, the monoalkenyl aromatic monomer includes styrene. In further embodiments, the monoalkenyl aromatic monomer includes styrene and the acrylic monomer includes glycidyl (meth)acrylate. In some such further embodiments, the vinylic monomers include from 40 to 65 wt.% of styrene and from 35 to 60 wt.% glycidyl (meth)acrylate.

According to the method, the reactor may be charged with a polymerization initiator. The initiators suitable for carrying out the process according to the present technology may thermally decompose into radicals in a first order reaction. Suitable initiators include those with half-life periods in the radical decomposition process of 1 hour at temperatures greater or equal to 90° C., and further include those with half-life periods in the radical decomposition process of 10 hours at temperatures greater or equal to 100° C. Others with 10 hour half-lives at temperatures lower than 100° C. may also be used. For example, and without limitation, the polymerization initiators may include, but is not limited to, 2,2′-azodi-(2,4- dimethylvaleronitrile); 2,2′-azobisisobutyronitrile (AIBN); 2,2′-azobis(2-methylbutyronitrile); 1,1′-azobis (cyclohexane-1-carbonitrile); tertiary butylperbenzoate; tert-amyl peroxy 2- ethylhexyl carbonate; 1,1-bis(tert-amylperoxy)cyclohexane, lauryl peroxide; succinic acid peroxide; or benzoyl peroxide. In some embodiments, the polymerization initiator includes 2,2′- azodi-(2,4-dimethylvaleronitrile); 2,2′-azobisisobutyronitrile (AIBN); or 2,2′-azobis(2- methylbutyronitrile). In other embodiments, the polymerization initiator includes lauryl peroxide; succinic acid peroxide; or benzoyl peroxide. The amount of polymerization initiator that is used is dependent upon the conditions of the reaction and may be adjusted accordingly. However, in some embodiments, the amount of polymerization initiator ranges from 0 wt,% to 5 wt.%, based upon the weight of the vinylic monomers, while in other embodiments, the amount ranges from 2 wt.% to 5 wt.%.

The reaction solvent may be fed into the reactor together with the monomers, or in a separate feed. The solvent may be any solvent well known in the art, including those that do not react with the epoxy functionality on the vinylic monomer(s) at the temperatures of the polymerization process described herein. Suitable reaction solvents for the methods include, but are not limited to, xylene, toluene, ethyl benzene, aromatic-100, aromatic-150, aromatic-200, acetone, methylethylketone, methylamylketone, methyl-iso-butylketone, N-methylpyrrolidinone, isopropanol or isoparaffins. The solvents are present in an amount desired, taking into account reactor conditions and monomer feed. In one embodiment, one or more solvents are present in an amount of from 20 wt.% to 80 wt.%, from 30 wt.% to 75 wt.%, and from 35 wt.% to 70 wt.%, based on the total weight of the monomers.

Styrene acrylic copolymers are produced by continuous bulk polymerization processes described, e.g., in U.S. Pat. Nos. 4,414,370, 4,529,787, 4,546,160, and 6, 984,694, each of which are incorporated herein by reference. All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

### EMBODIMENTS OF THE INVENTION

Illustrative embodiments of the present invention are listed below, but do not restrict the present invention. In particular, the present invention also encompasses those embodiments that result from the dependency references and hence combinations specified hereinafter. More particularly, in the case of naming of a range of embodiments hereinafter, for example the expression “The process according to any of embodiments 1 to 4”, should be understood such that any combination of the embodiments within this range is explicitly disclosed to the person skilled in the art, meaning that the expression should be regarded as being synonymous to “The process according to any of embodiments 1, 2, 3 and 4”:

Embodiment I: A composition comprising:
(i) at least one ester obtained by reacting at least one compound having 2 to 12 hydroxy groups and at least one C₆-C₂₄ monocarboxylic acid; and
(ii) at least one first styrene acrylic copolymer with a glass transition temperature in the range of from - 54° C. to 10° C., measured by differential scanning calorimetry according to ASTM D 7426 (2013).

Embodiment II: The composition according to embodiment I, wherein the at least one ester has melting point in the range of 50° C. to 90° C., determined according to ASTM D3418-15.

Embodiment III: The composition according to embodiment II, wherein the at least one ester has melting point in the range of 50° C. to 75° C., determined according to ASTM D3418-15.

Embodiment IV: The composition according to embodiment I, wherein the at least one compound having 2 to 12 hydroxy groups is selected from the group consisting of ethylene glycol, glycerol, erythritol, pentaerythritol, mesoerythritol, 1,2,6-hexanetriol, sorbitol, trimethylolpropane, 1,2,4-butanetriol, trimethylolethane, arabitol, xylitol, mannitol, dipentaerythritol, monosaccharides, disaccharides and polysaccharides.

Embodiment V: The composition according to embodiment IV, wherein the monosaccharides are selected from the group consisting of ribose, ribulose, arabinose, xylose, lyxose, glucose, fructose, galactose, mannose and sorbose.

Embodiment VI: The composition according to embodiment IV, wherein the polysaccharides are selected from the group consisting of dextrin and maltodextrin.

Embodiment VII: The composition according to embodiment IV, wherein the disaccharides are selected from the group consisting of maltose, lactose and sucrose.

Embodiment VIII: The composition according to embodiment I, wherein the at least one compound has 2 to 4 hydroxy groups.

Embodiment IX: The composition according to embodiment VIII, wherein the at least one compound having 2 to 4 hydroxy groups is selected from the group consisting of ethylene glycol, glycerol, erythritol, pentaerythritol, mesoerythritol, 1,2,6-hexanetriol and trimethylolpropane.

Embodiment X: The composition according to embodiment I, wherein the at least one compound has 2 hydroxy groups.

Embodiment XI: The composition according to embodiment X, wherein the at least one compound having 2 hydroxy groups is selected from the group consisting of ethylene glycol, propylene glycol, butylene glycol, 1,5-pentanediol and 1,6-hexanediol.

Embodiment XII: The composition according to embodiment X, wherein the at least one compound having 2 hydroxy groups is ethylene glycol.

Embodiment XIII: The composition according to embodiment I, wherein the at least one compound has 3 or 4 hydroxy groups.

Embodiment XIV: The composition according to embodiment XIII, wherein the at least one compound having 3 or 4 hydroxy groups is selected from the group consisting of glycerol, erythritol, pentaerythritol, mesoerythritol, 1,2,6-hexanetriol and trimethylolpropane.

Embodiment XV: The composition according to embodiment I, wherein the at least one compound has 4 hydroxy groups.

Embodiment XVI: The composition according to embodiment XV, wherein the at least one compound having 4 hydroxy groups is selected from the group consisting of pentaerythritol, ribose, ribulose, arabinose, xylose, erythritol and mesoerythritol.

Embodiment XVII: The composition according to embodiment I, wherein the at least one ester is selected from the group consisting of pentaerythritol tetrastearate, pentaerythritol oleate, pentaerythritol tetrabehenate, pentaerythritol tetraisopalmitate, glyceryl tristearate, erythritol distearate, sorbitan stearate and dipentaerythritol stearate.

Embodiment XVIII: The composition according to embodiment I, wherein the at least one C₆-C₂₄ monocarboxylic acid is selected from the group consisting of caproic acid, caprylic acid, capric acid, lauric acid, myristic acid, palmitic acid, stearic acid, oleic acid and behenic acid,

Embodiment XIX: The composition according to any of the embodiments I to XVIII, wherein the at least one ester is present in an amount in the range of 20 wt.% to 70 wt.%, based on the total weight of the coating composition.

Embodiment XX: The composition according to embodiment I, wherein the at least one first styrene acrylic copolymer is present in an amount in the range of 20 wt.% to 60 wt.%, based on the total weight of the coating composition.

Embodiment XXI: The composition according to embodiment I, wherein the at least one first styrene acrylic copolymer has a glass transition temperature in the range of from -35° C. to 5° C., measured by differential scanning calorimetry according to ASTM D 7426(2013).

Embodiment XXII: The composition according to embodiment I, wherein the at least one first styrene acrylic copolymer has a weight average molecular weight in the range of 1000 g/mol to 25,000 g/mol, measured by gel permeation chromatography according to ISO 13885-1(2008).

Embodiment XXIII: The composition according to embodiment I, wherein the at least one first styrene acrylic copolymer is obtained by polymerization of at least one (meth)acrylic monomer selected from the group consisting of acrylic acid, methacrylic acid, methylmethacrylic acid, methyl acrylate, methyl methacrylate, ethyl acrylate, ethyl methacrylate, a hydroxy vinyl ether, n-propyl acrylate, isopropyl acrylate, n-butyl acrylate, n-butyl methacrylate, isobutyl acrylate, isobutyl methacrylate, 2-ethylhexyl acrylate,2-ethylhexyl methacrylate, n-decyl acrylate, n-amyl acrylate, n-hexyl acrylate, isoamyl acrylate, 2-hydroxyethyl acrylate, 2-hydroxypropyl acrylate, N,N-dimethylaminoethyl acrylate, N,N-diethylaminoethyl acrylate, t-butylaminoethyl acrylate, 2-sulfoethyl acrylate, trifluorethyl acrylate, glycidyl acrylate, benzyl acrylate, allyl acrylate, 2-n-butoxyethyl acrylate, 2-chloroethyl acrylate, sec-butyl acrylate, tert-butyl acrylate, 2-ethylbutyl acrylate, cinnamyl acrylate, crotyl acrylate, cyclohexyl acrylate, cyclopentyl acrylate, 2-ethoxyethyl acrylate, furfuryl acrylate, hexafluoroisopropoyl acrylate, methallyl acrylate, 2-n-butoxyethyl methacrylate, 2-chloroethyl methacrylate, sec-butyl-methacrylate, tert-butyl methacrylate, 2-ethylbutyl methacrylate, cinnamyl methacrylate, crotyl methacrylate, cyclohexyl methacrylate, cyclopentyl methacrylate, 2-ethoxyethyl methacrylate, furfuryl methacrylate, hexafluoroisopropyl methacrylate, methallyl methacrylate, 3-methoxybutyl methacrylate, 2-methoxybutyl methacrylate, 2-nitro-2-methylpropyl methacrylate, n-octylmethacrylate, 2-ethylhexyl methacrylate, 2-phenoxyethyl methacrylate, 2-phenylethyl methacrylate, phenyl methacrylate, propargyl methacrylate, tetrahydrofurfuryl methacrylate, tetrahydropyranyl methacrylate, hydroxyalkyl acrylates and methacrylates, acrylic acid and its salts, acrylonitrile, acrylamide, methyl chloroacrylate, methyl 2-cyanoacrylate, N-ethylacrylamide, N,N-diethylacrylamide, acrolein, methacrylic acid and its salts, methacrylonitrile, methacrylamide, N-methylmethacrylamide, N-ethylmethacrylamide, N,N-diethylmethacrylamide, N,N-dimethylmethacrylamide, N-phenylmethacrylamide, methacrolein, or a mixture thereof and at least one styrene monomer.

Embodiment XXIV: The composition according to embodiment XXIII, wherein the at least one styrene monomer is selected from the group consisting of styrene, 1,3-dimethylstyrene, chlorostyrene, bromostyrene, α- methylstyrene, m-methylstyrene, p-methylstyrene, α-butylstyrene, 4-n-butylstyrene, 4-n-decylstyrene and combinations thereof.

Embodiment XXV: The composition according to embodiment XXIII, wherein the at least one (meth)acrylic monomer is present in polymerized form in an amount in the range of 10 wt.% to 70 wt.%, based on the total weight of at least one first styrene acrylic copolymer.

Embodiment XXVI: The composition according to embodiment XXIII, wherein the at least one styrene monomer is present in polymerized form in an amount in the range of 20 wt.% to 65 wt.%, based on the total weight of at least one first styrene acrylic copolymer.

Embodiment XXVII: The composition according to embodiment I, further comprising at least one second styrene acrylic copolymer with a glass transition temperature in the range of from 60° C. to 150° C., measured by differential scanning calorimetry according to ASTM D 7426(2013).

Embodiment XXVIII: The composition according to embodiment XXVII, wherein the at least one second styrene acrylic copolymer is present in an amount in the range of 10 wt.% to 40 wt.%, based on the total weight of the coating composition.

Embodiment XXIX: The composition according to embodiment XXVII, wherein the at least one second styrene acrylic copolymer has a glass transition temperature in the range of from 60° C. to 100° C. measured by differential scanning calorimetry according to ASTM D 7426(20130.

Embodiment XXX: The composition according to embodiment XXVII, wherein the at least one second styrene acrylic copolymer has a weight average molecular weight in the range of 1000 g/mol to 15,000 g/mol, measured by gel permeation chromatography according to ISO 13885-1(2008).

Embodiment XXXI: The composition according to embodiment XXVII, wherein the the at least one second styrene acrylic copolymer is obtained by polymerization of at least (meth)acrylic monomer selected from the group consisting of acrylic acid, methacrylic acid, methylmethacrylic acid, methyl acrylate, methyl methacrylate, ethyl acrylate, ethyl methacrylate, a hydroxy vinyl ether, n-propyl acrylate, isopropyl acrylate, n-butyl acrylate, n-butyl methacrylate, isobutyl acrylate, isobutyl methacrylate, 2-ethylhexyl acrylate,2-ethylhexyl methacrylate, n-decyl acrylate, n-amyl acrylate, n-hexyl acrylate, isoamyl acrylate, 2-hydroxyethyl acrylate, 2-hydroxypropyl acrylate, N,N-dimethylaminoethyl acrylate, N,N-diethylaminoethyl acrylate, t-butylaminoethyl acrylate, 2-sulfoethyl acrylate, trifluorethyl acrylate, glycidyl acrylate, benzyl acrylate, allyl acrylate, 2-n-butoxyethyl acrylate, 2-chloroethyl acrylate, sec-butyl acrylate, tert-butyl acrylate, 2-ethylbutyl acrylate, cinnamyl acrylate, crotyl acrylate, cyclohexyl acrylate, cyclopentyl acrylate, 2-ethoxyethyl acrylate, furfuryl acrylate, hexafluoroisopropoyl acrylate, methallyl acrylate, 2-n-butoxyethyl methacrylate, 2-chloroethyl methacrylate, sec-butyl-methacrylate, tert-butyl methacrylate, 2-ethylbutyl methacrylate, cinnamyl methacrylate, crotyl methacrylate, cyclohexyl methacrylate, cyclopentyl methacrylate, 2-ethoxyethyl methacrylate, furfuryl methacrylate, hexafluoroisopropyl methacrylate, methallyl methacrylate, 3-methoxybutyl methacrylate, 2-methoxybutyl methacrylate, 2-nitro-2-methylpropyl methacrylate, n-octylmethacrylate, 2-ethylhexyl methacrylate, 2-phenoxyethyl methacrylate, 2-phenylethyl methacrylate, phenyl methacrylate, propargyl methacrylate, tetrahydrofurfuryl methacrylate, tetrahydropyranyl methacrylate, hydroxyalkyl acrylates and methacrylates, acrylic acid and its salts, acrylonitrile, acrylamide, methyl chloroacrylate, methyl 2-cyanoacrylate, N-ethylacrylamide, N,N-diethylacrylamide, acrolein, methacrylic acid and its salts, methacrylonitrile, methacrylamide, N-methylmethacrylamide, N-ethylmethacrylamide, N,N-diethylmethacrylamide, N,N-dimethylmethacrylamide, N-phenylmethacrylamide, methacrolein, or a mixture thereof and at least one styrene monomer..

Embodiment XXXII: The composition according to embodiment XXXI, wherein the at least one styrene monomer is selected from the group consisting of styrene, 1,3-dimethylstyrene, chlorostyrene, bromostyrene, α- methylstyrene, m-methylstyrene, p-methylstyrene, α-butylstyrene, 4-n-butylstyrene, 4-n-decylstyrene and combinations thereof

Embodiment XXXIII: The composition according to embodiment XXXI, wherein the at least one (meth)acrylic monomer is present in polymerized form in an amount in the range of 10 wt.% to 60 wt.%, based on the total weight of at least one second styrene acrylic copolymer.

Embodiment XXXIV: The composition according to embodiment XXXI, wherein the at least one styrene monomer is present in polymerized form in an amount in the range of 20 wt.% to 85 wt.%, based on the total weight of at least one second styrene acrylic copolymer.

Embodiment XXXV The composition according to any of the embodiments I to XXXIV, further comprising at least one rheology modifier.

Embodiment XXXVI: The composition according to embodiment XXXV, wherein the at least one rheology modifier is selected from the group consisting of modified high-density polyethylene, metallocene polyethylene wax and modified hydrogenated castor oil.

Embodiment XXXVII: The composition according to embodiment XXXV or XXXVI, wherein the at least one rheology modifier is present in an amount in the range of 0.5 wt.% to 4.0 wt.%, based on the total weight of the coating composition.

Embodiment XXXVIII: The composition according to any of the embodiments I to XXXV, further comprising at least one anti-blocking agent.

Embodiment XXXIX: The composition according to embodiment XXXVIII, wherein the at least one anti-blocking agent is selected from the group consisting of talc, aluminum oxide powder, silica and fatty amides.

Embodiment XL: The composition according to embodiment XXXVIII or XXXIX, wherein the at least one anti- blocking agent is present in an amount in the range of 0.5 wt.% to 3 wt.%, based on the total weight of the coating composition.

Embodiment XLI: The composition according to embodiment I, wherein the melt viscosity of the composition is in the range of 100 cP to 2000 cP at temperature in the range of 90° C. to 130° C., determined according to method ASTM 2196-18.

Embodiment XLII: A process for preparing the composition according to any of the embodiments I to XLI comprising at least the steps of:
(i) mixing of at least one ester and at least one first styrene acrylic copolymer to form a mixture;
(ii) heating the mixture to a temperature in the range of from 90° C. to 140° C. ; and wherein the at least one ester is obtained by reacting at least one compound having 2 to 12 hydroxy groups and at least one C₆-C₂₄ monocarboxylic acid.

Embodiment XLIII: A coating comprising the composition according to any of the embodiments I to XLI.

Embodiment XLIV: A substrate coated on at least one surface with the coating according to embodiment XLIII.

Embodiment XLV: The substrate according to embodiment XLIV, wherein the substrate is selected from the group consisting of coated paper, uncoated paper and paperboard.

Embodiment XLVI: Paper stock comprising a substrate coated with the coating according to embodiment XLIII.

While the presently claimed invention has been described in terms of its specific embodiments, certain modifications and equivalents will be apparent to those skilled in the art and are intended to be included within the scope of the presently claimed invention.

The presently claimed invention is associated with at least one of the following advantages:
(i) The presently claimed invention provides a composition that on coating a substrate is recyclable and repulpable.
(ii) The composition of the presently claimed invention provides improved block resistance, water resistance and melt viscosity.
(iii) The coating comprising the composition of the presently claimed invention can be removed from the substrate under standard operating repulping procedures as described in the test methods.
(iv) The recycled paper produced exhibits good physical strength.
(v) The presently claimed invention provides a composition that on coating a substrate is repulpable.

### EXAMPLES

Aspects of the presently claimed invention are more fully illustrated by the following examples, which are set forth to illustrate certain aspects of the present invention and are not to be construed as limiting thereof.

### Synthesis of Ester

Preparation of pentaerythritol tetrastearate: To a clean, dry reactor, fatty acid cut (pure or mixed fatty acids (i.e. C₁₈, C₁₆/C₁₈) and crystalline pentaerythritol were added. The reactor was heated to 120° C. and agitated. Methane sulfonic acid (MSA) was added subsequently to the reactor. The reactor was placed under nitrogen blanket and was heated to 160° C. It was allowed to react for 1 hour and distillate was collected. Pressure was reduced stepwise from 760 mmHg to 50 mmHg over the course of 2 hours. The reaction was continued at 50 mmHg for 2 additional hours collecting distillate. The acid value was monitored and was targeted to achieve less than 20 mg KOH/ 1 g sample. H NMR: (400 MHz, CDCl3) δ 4.11 (s, 8H), 2.30 (t, 8H), 1.59 (m, 8H), 1.25 (m, 106), 0.88 (t, 12H).

Synthesis of first and second styrene acrylic copolymer: Styrene acrylic copolymers were synthesized using a continuous stirred tank reactor equipped with an overhead agitator and heating mantle. The monomer feed was continuously pumped to the reactor to maintain a residence time of 12-15 min. The resulting polymer was passed through a flash tank that operates at elevated temperatures (200-280° C.) and vacuum to remove residual monomer and solvent. The stripped resin was captured in a collection vessel while the distillate is condensed in water-cooled condenser and collected in the distillate vessel.

Preparation of the composition blend: At the laboratory scale, preparation of a composition blend was done via hot plate with magnetic stir bar or an open glassware with overhead mixer for materials requiring higher temperatures. Compatibility of a blend was determined visually throughout a heat aging process of up to 3 weeks. Blends were commonly held at 120° C. or 130° C., depending on composition, and with cycles of heating and cooling to room temperature.

### Formulation 1

The pentaerythritol wax (69 wt.%) and ‘liquid’ (low Tg) styrene acrylic copolymer component (29.6 wt.%, M_{w} = 17,000 Da, T_{g} = -21° C.) were heated to ~120° C. to facilitate the handling of the styrene acrylic copolymer, while the wax can be handled at any temperature above its melt point. Wax and styrene acrylic copolymer were weighed into a 120 mL glass jar and was typically placed in an oven long enough for the jar and components to reach the desired blending temperature so that the hot plate needs merely to maintain sample temperature during blending. Oxidized polyethylene wax (1.5 wt.%) was added during the blending process to ensure good mixing. The sample was then transferred to a hot plate and, using a magnetic stir bar, blended for at least 15 minutes or until there are no visible solids. Temperature was set to maintain the sample above the melt point of the highest-melting component, and it is during this time any other additives were added. RPMs were adjusted based on sample composition to provide consistent stirring and typically to achieve a vortex or whirlpool effect. A thermometer was used to track sample temperature as the hot plate must be set higher than the desired mixing temperature to keep the sample at that mixing temperature.

### Formulation 2

The ‘liquid’ styrene acrylic copolymer component (56 wt.%, M_{w} = 6600 Da, T_{g} = -10° C.) was heated to ~120° C. and was weighed into a 120 mL jar. The higher Tg ‘solid’ styrene acrylic copolymer was then weighed into the jar (24 wt.%, M_{w} = 5900 Da, T_{g} = 69° C.) and the sample was placed in an oven to reduce initial heating needed by the glassware during blending. The ‘solid’ styrene acrylic copolymer requires more heat than can be provided by a hot plate, so the jar was transferred to an open glassware and an overhead mixer was used for blending. The styrene acrylic copolymers were blended for 15 minutes or long enough for the blend to become clear and homogenous. Temperature was measured by thermometer at various times throughout the blending and temperature creep was not noticed when using this equipment. A sample temperature approximately doubles the Tg of the ‘solid’ styrene acrylic copolymer was targeted while RPMs of ~700 have proved sufficient for blending. The styrene acrylic copolymer compatibility was tested overnight, the samples were held in an oven at ~130° C. The samples were stirred and if the styrene acrylic copolymers were visually homogenous, the pentaerythritol wax was weighed in at 20 wt.% and the sample was placed back in the glassware at the styrene acrylic copolymer blend temperature / RPMs and was blended for another 15 minutes. The blend typically takes on a white or off-white color and becomes opaque. Compatibility was again tested overnight at ~130° C., to check visual separation or non-homogeneity.

### Rheology Additive

To increase the viscosity at application conditions various additives were tried with the most successful additives being oxidized waxes of higher melting temperatures, above 120° C. These additives were added in the blending process and were typically melted into the sample rather than attempting to disperse as solids.

### Antiblock Additives

To improve blocking at 50° C. various commercial products were tried, added in in the same manner as rheology modifying additives

### Effect of Neutralization

In order to minimize the generation of butyl compounds when samples were held at elevated temperatures the methane sulfonic acid catalyst from the pentaerythritol tetrastearate wax must be neutralized. Initial testing indicated that non-neutralized wax was necessary to create stability between the wax and the styrene acrylic copolymer and phase separation can occur if the wax is neutralized prior to blending with the styrene acrylic copolymer. In the lab the neutralizing agent, sodium bicarbonate, was charged at 2 g for a 40 g sample (~27 g wax). This amounts to 117 molar equivalents of sodium carbonate to acid catalyst. The extreme excess was done both to be confident of the neutralization as well as making it easily observable. Neutralization procedure was to blend the wax and styrene acrylic copolymer according to standard procedure for 15 minutes prior to adding the neutralizing agent, and then blending was continued for at least 15 minutes after addition. The blend was then poured through a 25 um filter and readied for any further processing or material additions. The sodium bicarbonate sank to the bottom immediately after agitation was stopped, so the blend was decanted through the filter to avoid entirely the need to filter the bulk of the sodium bicarbonate.

TABLE 1

Composition of an ester: pentaerythritol tetrastearate

| Component | Amount | Moles | Wt.% | Mol.% |
|---|---|---|---|---|
| Pentaerythritol | 136.15 | 1.00 | 11.05% | 19.92 |
| Stearic acid | 1093.92 | 4.00 | 88.79% | 79.68 |
| Methanesulfonic acid (MSA) | 2.4 | 0.025 | 0.20% | 0.50 |

where,
Pentaerythritol was obtained from Perstorp
Stearic acid was obtained from Vantage Speciality Chemicals
Methanesulfonic acid was obtained from BASF Corporation

TABLE 2

Characterization of pentaerythritol derivatives

| Ester sample | Core (wt.%) | Fatty acid (wt.%) | Catalyst | Catalyst Wt.% | Acid value | Melting point | Weight average molecular weight Mw (g/mol) |
|---|---|---|---|---|---|---|---|
| WE-1 | Pentaerythritol (10.64 wt.%) | C18 (88.96 wt.%) | H3PO4 | 0.4 | 14 | 53 | 1200 |
| WE-2 | Pentaerythritol (9.07 wt.%) | C22 (90.68 wt.%) | MSA | 0.25 | 17 | 71 | 1430 |
| WE-3 | Pentaerythritol (11.06 wt.%) | C16,18 (34:65) (88.83 wt.%) | MSA | 0.12 | 20 | 55 | 1100 |
| WE-4 | Pentaerythritol (11.05 wt.%) | C16,18 (34:65) (88.80 wt.%) | MSA | 0.15 | 14 | 54 | 1100 |
| WE-5 | Pentaerythritol (11.05 wt.%) | C16,18 (34:65) (88.75 wt.%) | MSA | 0.20 | 16 | 55 | 1100 |
| WE-6 | Pentaerythritol (11.05 wt.%) | C16.18 (34:65) (88.79 wt.%) | MSA | 0.16 | 14 | 55 | 1100 |
| WE-7 | Pentaerythritol (11.05 wt.%) | C16.18 (34:65) (88.79 wt.%) | MSA | 0.16 | 11 | 54 | 1100 |
| WE-8 | Pentaerythritol (11.06 wt.%) | C16.18 (34:65) (88.83 wt.%) | MSA | 0.12 | 13 | 54 | 1100 |

where,
Pentaerythritol was obtained from Perstorp
H3PO4 was obtained from VWR Scientific
MSA was obtained from Sigma Aldrich
C16/C18 fatty acids were obtained from Vantage Speciality Chemicals
C22 fatty acids were obtained from Alfa Assar
C18 fatty acids were obtained from Vantage Speciality Chemicals

TABLE 3

Styrene acrylic copolymer composition

| Styrene Acrylic Copolymer sample | BA (wt.%) | 2-EHA (wt.%) | STY (wt.%) | MMA (wt.%) | Mw (kDa) | Tg (°C) |
|---|---|---|---|---|---|---|
| A | 19 | 46 | 35 | | 15.9 | -26 |
| B | | | 80 | 20 | 6 | 70 |
| C | 19 | 46 | 35 | | 15 | -28 |
| D | | | 80 | 20 | 5.9 | 69 |
| E | | 49 | 51 | | 6.6 | -9 |
| F | | 49 | 51 | | 10 | -10 |

where,
BA is butyl acrylate was obtained from Sigma Aldrich
2-EHA is 2-ethyl hexyl acrylate was obtained from Sigma Aldrich
STY is styrene was obtained from Sigma Aldrich
MMA is methyl methacrylate was obtained from Sigma Aldrich

The composition details of ester can be obtained from Table 2 and composition details of styrene acrylic copolymer can be obtained from Table 3.

TABLE 4

Composition Blend

| | | | | | |
|---|---|---|---|---|---|
| | Ester (wt.%) | First styrene acrylic copolymer (wt.%) | Second styrene acrylic copolymer (wt.%) | Rheology additive (wt.%) | Antiblock additive (wt.%) |
| Example 1 | WE-6 (68.6) | A (29.4) | | Aqua-Poly 250 (1.0) | Crodamide VRX (1.0) |
| Example 2 | WE-7 (40.0) | B (15.0) | F (45.0) | | |
| Example 3 | WE-8 (66.5) | C (28.5) | | Aqua-Poly 215 (4.0) | Crodamide VRX (1.0) |
| Example 4 | Loxiol G59 (30.0) | D (35.0) | E (35.0) | | |
| Example 5 | | D (50.0) | E (50.0) | | |
| Example 6 | | D (100.0) | | | |

where,
AquaPoly 250 is polyethylene wax, was obtained from Micro Powders, Inc.
AquaPoly 215 is polyethylene wax, was obtained from Micro Powders, Inc.
Crodamide VRX is oleamide, was obtained from Croda Polymer Additives
Loxiol G 59 is fatty acid ester, was obtained from Emery Oleochemicals GmbH

### Solubility

Solubility of the composition blend was based on whether the blend formed distinct layers after freezing and re-melting. Immiscible liquid blends form visible layers whereas acceptable blends remained homogeneous after re-melting. It was found that the inventive composition blends remained homogenous after re-melting.

### Coating the Blend

Laboratory coating was done using a ChemInstruments Hot Melt Coater with liner paper used as substrate. The heated coating bars and heated reservoir dam were all set to 65.6° C. and the gap was set to 303 µm. Temperature was set by the control unit and the gap was measured using a feeler gauge. Sample composition and temperature will affect the coat weight applied. Samples were held in an oven at 130° C. until ready to be applied. When removed from the oven a thermometer was used to stir the sample and measure temperature, when the sample cooled to 110° C. it was poured into the coater’s reservoir and the substrate was drawn through the gap. Samples typically cool to solid within 5 seconds and can be set aside immediately after cooling. Solidification will occur in the reservoir by the end of the drawdown, this material was cleaned away prior to additional testing. The target coating weights are in the range of from 20 gm to 50 gm.

### Coating Characterization

Coat weight can vary along the length of a drawdown so the coat weight of samples must be calculated before conducting any testing or characterization. Coated samples were left to sit in a CTH room at 25° C. and 50% relative humidity for a minimum of 4 hours to equilibrate to a consistent water content. Using a paper cutter, drawdown samples were cut into 5″×4″ rectangles which should remove any coating edges where there may be inconsistent coating and leave a completely coated sheet. A 5″×4″ sheet of the liner paper substrate weighs on average 2.2154 g with a sample standard deviation of 0.0245 g and from this the amount of coating on any coated sample can be calculated.

### Block Testing

Block testing was done at 201bf and 50° C. for 4 hours. A coated sample of desired coat weight was cut into strips of 1 inch wide by approximately 4 inches in length. These samples were stacked together such that two coated faces were in contact and a third coated face was against the uncoated side of either of the other two pieces. This was done in duplicate for each sample and these 3-piece stacks were themselves stacked and placed in a block tester. The spring was screwed down to the desired pressure based on its calibration table and the entire assembly was placed into an oven at the desired temperature. The tests measure the extent of tackiness and damage that a coated substrate experiences when subjected to standard temperature, pressure, and time. Rolls of coated paper stock can achieve an internal pressure of up to 60 psi, depending on paper uniformity. When stored or transported under tropical conditions (30° C. and 95% relative humidity), coated paper layers can stick together, and, in the worst case scenario, the paper or coating can be significantly damaged. Samples were cut 1 × 3 inches and two sheets were layered coating-to-paper (face-to-back, F-B) or coating-to-coating (face-to-face, F-F) in a block testing apparatus. A spring was then placed on top of the layers to apply a certain amount of pressure on the samples. The entire apparatus was placed in an oven capable of humid conditions at 50° C. for 24 hours. When the block test was completed, the samples were removed and monitored for tack and damage of samples.

TABLE 5

Block Testing

| | | | |
|---|---|---|---|
| | Test Length | Replicate | Face/Face |
| Comparative Example 1* | 4 hours | 1 2 | 5 5 |
| Example 1 | 4 hours | 1 2 | 4 4 |
| Example 2 | 4 hours | 1 2 | 3 4 |
| Example 3 | 4 hours | 1 2 | 4 4 |
| Example 4 | 4 hours | 1 2 | 4 4 |
| Example 5 | Too brittle, coating fractures as substrate bends | | |
| Example 6 | Too brittle, coating fractures as substrate bends | | |

where, Comparative Example 1* is a paraffin composition that was obtained from The International Group Inc. The paraffin composition has a melting point temperature in the range of 64° C. to 68° C. measured according to ASTM D87 and a viscosity in the range of 5 cSt to 6.6 cSt at 100° C. measured according to ASTM D445.

Block Rating System

| | |
|---|---|
| 5 | no cling, no stain, no coating damage |
| 4 | slight cling, slight stain, no coating damage |
| 3 | cling, staining, coating damage or transfer |
| 2 | coating-substrate failure |
| 1 | substrate damage |
| 0 | severe substrate damage, coating fusion |

### Cobb Testing

Cobb testing is a TAPPI procedure, described by TAPPI T 441 (2001), which is incorporated by reference herein in its entirety is used to quantify water absorptiveness. This method determines the amount of liquid water or moisture vapor absorbed by paper, paperboard, and corrugated fiberboard in a specified time under standardized conditions. The Cobb value of a material is the mass of water absorbed in a specified time by 1 m2 of the material being testing, under 1cm of water. Cobb testing was done at CTH with deionized water for 30 minutes. The laboratory apparatus is a ring with an interior area of 25 cm2 and clamp that holds the ring against the drawdown to be tested. A larger ring which would provide increased accuracy, area of 100 cm2, was available but the substrate used in the lab does not allow for a sample of sufficient diameter. The sample to be tested was cut so it is close, but larger in area than the ring. This circle of sample was weighed, and the initial weight was recorded. With the ring secured on the sample with enough force to create a watertight seal, 25 mL of deionized water was poured into the ring and it was left to sit at CTH for 30 minutes. When the time expired the sample was quickly inverted to empty the water and the sample was carefully removed from the apparatus with care to not expose it to water. This sample was immediately placed between sheets of blotter paper and a couch roller was passed over in one direction, and again in the return direction. The sample was weighed and compared to the initial weight to determine water absorption. This was converted to the equivalent of 1 m2 of material.

Depending on the tackiness and composition of the formulation used it was possible for the sample to become stuck to the test ring. In these cases, a quantifiable value of water absorption cannot be determined, and the test will have to be repeated with less pressure exerted by the Cobb test clamp. A qualitative assessment of the sample should still be made, although it is not unusual for there to be no appearance of water damage on the sample.

TABLE 6

Cobb Testing

| | Replicate | Ring Area (cm²) | Delta Mass (g) | Cobb Value (g/m²) | Average Cobb (g/m²) | σ |
|---|---|---|---|---|---|---|
| Comparative Example 1* | 1 | 25 | 0.0014 | 0.5600 | 0.9200 | 0.36 |
| | 2 | | 0.0032 | 1.2800 | | |
| Example 1 | 1 | 25 | 0.0013 | 0.5200 | 0.6600 | 0.14 |
| | 2 | | 0.0020 | 0.0800 | | |
| Example 2 | 1 | 25 | 0.0028 | 1.12 | 0.9000 | 0.31 |
| | 2 | | 0.0017 | 0.68 | | |
| Example 3 | 1 | 25 | 0.0034 | 1.3600 | 1.2400 | 0.12 |
| | 2 | | 0.0028 | 1.1200 | | |
| Example 4 | 1 | 25 | 0.0005 | 0.2000 | 0.0000 | 0.2 |
| | 2 | | -0.0005 | -0.2000 | | |
| Example 5 | 1 | Too brittle, coating fractures as substrate bends | | | | |
| | 2 | | | | | |
| Example 6 | 1 | Too brittle, coating fractures as substrate bends | | | | |
| | 2 | | | | | |

where, Comparative Example 1* is a paraffin composition was obtained from The International Group Inc. The paraffin composition has a melting point temperature in the range of 64° C. to 68° C. measured according to ASTM D87 and a viscosity in the range of 5 cSt to 6.6 cSt at 100° C. measured according to ASTM D445.

### Slide Angle

Slide Angle is a TAPPI procedure, described by TAPPI T 815, which is incorporated by reference herein in its entirety. Slide angle testing uses a 4 lb sled and a motorized track to determine at what angle two coating surfaces will slide past one another. One sample was cut into two 2″×7″ pieces and, using the scoring template, one piece was scored and folded along the score. The scored and folded sample was wrapped around the sled from the front, underneath, and to the back with the coating facing out. The unscored sample was placed in the clamp on the track with the coating facing up. With the track in the horizontal position the sled is put into place and the track rose until the sled slides forward, cutting off the motor. The angle of the track is measured and recorded, and the process was repeated with the same samples.

It has been found that the Slide Angle increases over several runs as the coating becomes worn. To maintain a repeatable test, each pair of samples was run only twice with three sets of samples being completed.

TABLE 7

Slide Angle Test

| | | |
|---|---|---|
| | Average | σ |
| Comparative Example 1* | 27.8 | 1.1 |
| Example 1 | 33.0 | 0.4 |
| Example 2 | 59.7 | 0.6 |
| Example 3 | 36.0 | 0.8 |
| Example 4 | 27.4 | 0.4 |
| Example 5 | N/A | |
| Example 6 | N/A | |

where, Comparative Example 1* is a paraffin composition was obtained from The International Group Inc. The paraffin composition has a melting point temperature in the range of 64° C. to 68° C. measured according to ASTM D87 and a viscosity in the range of 5 cSt to 6.6 cSt at 100° C. measured according to ASTM D445.

### Recyclability

Recyclability testing was done on single-side lab coated samples using liner paper as a substrate. Coat weights were calculated prior to testing. Based on the equipment used in this recyclability process a total of 25 g of paper was used to generate sufficient pulp to create recycled sheets meeting the desired specifications.

Industrial recycling typically uses 80% clean pulp to 20% recycled pulp and as such 80% of the 25 g in this process was uncoated liner paper or paperboard. Additionally, based on Western Michigan University’s paper recycling lab, the repulping phase was done in a heated tank by maintaining a temperature of 135° F. (57.2° C.), so warm tap water was used for the repulping step in this procedure.

The laboratory recycling procedure was based on a series of TAPPI testing standards that are written as stand-alone processes to determine various properties of the paper fiber as it passes through steps of a full recycling process and were not originally designed to mimic a full recycling process.

### Repulpability

Samples were cut into 1.25″×4″ strips and added to a Waring CB15 blender with a specially designed paddle-style blade. This paddle blade is designed to beat the paper and cause the fibers to fall apart rather than cause scission of the fibers. 1,500 mL of warm water was added and the sample was blended on the “Low” setting for 4 minutes. The product of this step was typically well-saturated pulp bundles of 1 cm diameter, but with large variance in size. Occasionally a piece of paperboard remained in sheet form after this step, something near 5 cm in diameter, which was likely a result of either an inconstancy in the paperboard feedstock density or the piece getting caught on the paddle blade early in the blending step. Such a piece was simply added to the disintegrator as-is in next process step. The blending product was transferred to a disintegrator meeting TAPPI T-205 specifications with an additional 500 mL of warm water to rinse the blender. The disintegrator is designed to further separate the paper fibers without changing their structural properties. The now 2,000 mL of water and pulp were ran on this disintegrator for 15,000 revolutions and the product appeared as smaller fiber bundles.

### Filtration and Dilution of Stock Solution

The fiber slurry from the disintegrator was run though a Somerville screen for 20 minutes with a recycled water stream. This filtration unit was a small tank with a screen at the bottom that then feeds to a fine mesh screen. When the tank filled with water it began to shake which causes the fibers to sift through the screen and pass onto the fine mesh screen. The fiber that passes through the first screen but is caught by the mesh were counted as “accepts” while the fiber that does not pass through the first screen or passes through the mesh were considered the “rejects.”

The lab Somerville was replumed to recycle the water after it passes through the mesh screen, a typical unit would have a constant fresh-water feed. This was done to avoid ‘washing’ the paper fibers with an unrealistic amount of clean water.

One of the criteria for a material to be considered recyclable is a fiber recovery of 80% of the initial unpulped feed, by dry weight, at this step. The inventive examples or compositions prepared according to the present invention have not shown any issues with fiber recovery in this process.

### Forming Hand Sheets

The sheet former is a square, open-top tank with a water feed and sides that are hinged. The bottom of the tank is a fine mesh screen that leads to a drain and the hinge allows the tank to be opened to expose the screen.

An amount of the stock solution was added, calculated from the solution’s pulp concentration, to achieve a hand sheet of 4 g. The water feed was used to fill the remainder of the tank to approximately 1 inch from the top. This allowed the fibers to become dilute and have freedom of movement in tank.

The diluted solution in the hand sheet former was agitated carefully to induce as random an orientation of the fibers as possible. This was done through smooth, but erratic movements of a spatula or similar tool. Changing direction and height/depth was necessary when agitating to give a random orientation. Aggressive mixing can cause splashing and loss of fiber and stirring constantly in one direction imparts to much fiber orientation so both must be avoided.

When well agitated, the spatula was gently removed by lifting vertically, again to avoid any splashing and to minimize any fiber becoming stuck to the tool. Immediately the sheet former was drained causing the fibers to layer on top of the screen, forming a mat or sheet of pulp. The sides of the tank were opened to expose this sheet and two sheets of blotter paper were laid with the smooth/fine side facing the sheet. A couch roller was rolled over the blotter paper four passes, once forward, once back, then repeated. This compresses the sheet and causes the blotter paper to absorb much of the water from the fiber sheet. Starting at a corner the fiber sheet can be carefully peeled away from the screen, the outer sheet of blotter paper was discarded, and the inner sheet holds the fibers to it.

A new sheet of blotter paper was placed over the exposed side of the fiber sheet, smooth/fine side towards the fibers. This sample can be placed in the press. It is important to recognize and note which side of the formed hand sheet was in contact with the mesh screen of the sheet former, known as the wire side of the sheet. Since it was formed in physical contact with the screen, this wire side will be smoother that the reverse blotter side, all surface testing was done on the wire side of the formed sheets.

The samples when transferred from the stock solution had particulates. These particulates tend to deposit on the surface of the sheet once formed and will melt into dark spots when the sheet is dried. The sheet former used in the lab as a small defect in the mesh that results in an area near the corner where pulp will not settle. This can be used as an aid to determine sheet orientation.

### Pressing and Drying

Sheets made on the former were pressed before testing to achieve appropriate fiber matrix strength. A lower and upper layer of two blotter sheets were placed on the base of the press followed by a fiber sheet between two sheets of blotter paper. Two additional sheets of blotter paper were used as a spacer before the next sample and this pattern was repeated until there are two blotter sheets on the top of the stack of samples. The lid was placed on the press and secured down.

The press has a round plate approximately 33 in² (0.021 m²) and was run at 50 psi for 2 minutes before pressure was released. The sheets were unstacked and each fiber sheet, still between the blotter paper, was passed through a drum drier. The drier was set to 180° F. (82.2° C.) but temperature of this unit was not steady and may creep above 200° F., difference in drying temperatures was not seen to affect the final properties of the sheets. Sheets were passed through the drier once, then again with the side that first contacted the drum facing outward. Sheets should be dry after two passes and are removed from the blotter sheets and immediately weighed to get a dry weight of approximately 5 g per sheet.

### Hand Sheet Testing

Hand sheets were mounted vertically and spaced out to allow for surface exposure then left in in a CTH room at 23° C. and 50% relative humidity for a minimum of 4 hours to equilibrate to a consistent water content. All surface testing was done on the wire side of the sheet. The TAPPI document “Voluntary Standard for Repulping and Recycling Corrugated Fiberboard Treated to Improve Its Performance in the Presence of Water and Water Vapor,” lists several test methods and the performance requirements that must be satisfied to consider a sample to be deemed recyclable.

### Inspection

Sheets were visually inspected appearance with respect to what is termed dirt spots, any type of impurity that was trapped by the fibers during the recycling process was visible on the sheet surface. For the samples prepared, the most common type of dirt spot is a dot of wax that came from the sheet forming step and appeared as a dark spot that repels water. To satisfy industry standards, per the “Voluntary Standard” document, the appearance of the handsheets made from the recyclability test sample shows no substantial difference from that of the handsheets made from the control and the spot count was ≤ 15 counts, or not exceeding 30% greater counts than the control, with an area ≥ 0.4 mm², averaged over 3 sheets.

Recyclability sample is made into hand sheets created with pulp from 80% control (untreated corrugated) and 20% treated [T-205] and tested for: Slide Angle [T-815]

TABLE 8

Recyclability

| Sample | Average ( °) | 85% Average_{c} | Average_{R} > 85% Average_{c} |
|---|---|---|---|
| Comparative Example 1* | 22.8 | 19.38 | |
| Example 1 | 21.8 | | Yes |
| Example 4 | 23.8 | | Yes |

where, Comparative Example 1* is untreated corrugated

TABLE 9

Repulpability

| Sample | Replicate | Mass (g) | Accepts (g) | Rejects (g) | Fiber yield (%) | Pass/Fail |
|---|---|---|---|---|---|---|
| Comparative Example 1* | 1 | 25.55 | 13.42 | 9.555 | 58.4 | Fail** |
| | 2 | 24.83 | 13.47 | 8.775 | 60.5 | Fail** |
| Example 1 | 1 | 25.0 | 19.87 | 0.296 | 58.4 | Pass |
| | 2 | 25.0 | 20.00 | 0.356 | 60.5 | Pass |
| Example 1 +10% paraffin | 1 | 25.0 | 21.15 | 0.515 | 97.6 | Pass** |
| | 2 | 25.0 | 21.40 | 0.320 | 98.5 | Pass** |
| Example 1 +20% paraffin | 1 | 25.0 | 20.62 | 0.974 | 95.5 | Pass** |
| | 2 | 25.0 | 20.99 | 0.864 | 96.0 | Pass** |
| Example 4 | 1 | 25.0 | 23.8243 | 0.813 | 96.7 | Pass |

where, Comparative Example 1* is a paraffin composition ** wax film build-up on inside of blender and disintegrator

The fiber yield or % of accepts is calculated by the following equation,

$$\begin{matrix}F i b e r y i e l d o r \% o f a c c e p t s = \frac{N e t A c c e p t s \times 100}{N e t A c c e p t s + N e t R e j e c t s} , \\ \text{where} \text{pass} > 85 \%\end{matrix}$$

### Water Pick-Up Rates

Water drop testing, or water pick-up rate, was used to measure how readily the recycled sheet absorbed water with the assumption that a high rate of absorption corresponds to a low level of coating retained with the fibers. Based on the “Voluntary Standard,” the water drop penetration of handsheets made from the recyclability test sample must not exceed the water drop penetration of the control handsheets by more than 200 seconds. Testing was done in a CTH at 23° C. and 50%RH. A sheet was placed on a ring stand to allow observation of the reverse side of the sheet without moving the sheet. A drop of deionized water was dripped onto the sheet and timed until there is no standing water from the drop on the surface of the sheet. Care was taken to only test areas of the sheet were there are no dirt spots or surface defects.

### Water Drop Penetration Determination

As per the voluntary standard TAPPI T 831, a coated sample was placed on a rack or ring so that the lower (uncoated) side can be observed. A burette or stopper, which will deliver 20 drops/cm³ of distilled or deionized water, was placed 1″ (25 mm) above the top (coated) surface of the sample. A single drop of water was dropped onto the surface of the specimen and a stopwatch was immediately started. The time for penetration of the drop through the sample was recorded when the first visual indication of wetting of the lower surface. This was repeated for at least 5 samples, with the average reported for a particular coating.

TABLE 10

Water drop penetration

| Sample | Average of 10 drop (s) | 200+ Average_{c} | Average_{R} ≤ 200 + Average_{C} |
|---|---|---|---|
| Comparative Example 1* | 3.39 | 203.39 | |
| Example 1 | 3600 | | No |
| Example 4 | 5.67 | | Yes |

where, Comparative Example 1* is untreated corrugated

### Short Span Compression Determination (STFI)

As per voluntary standard TAPPI T 826, a test specimen that is 15 mm (0.59″) wide, was held between two clamps 0.7 mm (0.028″) apart in a compression tester. The compression tester shall be 30 mm (1.18″) deep and have a surface of high friction, for example, a sand-blasted surface. The clamps shall grip the test specimen firmly over its full width with a constant clamping force of 2300 + 500 N (517 ± 112 lb). The stationary jaws shall be on the same side of the test specimen and clamping surfaces of the movable jaws in the same plane and parallel to the stationary jaws. The clamps were forced toward each other until a compressive failure occurs. The maximum force causing failure was measured in kN/m (or lb/in) and reported as an average of a minimum of five tests. If the basis weight was measured, as per TAPP T 410, this can be reported as an index value (STFI value/basis weight [in g/m² or lb/1000 ft²]).

TABLE 11

Short span compression determination

| Sample | Replicate | Handsheet weight (g) | Basis Wt. (lb/1000 ft²) | STFI Value [lb_{f}/in] | Indexed Value | Indexed Average | Indexed Average_{c} – 10% | Indexed Average_{g} ≥ In-dexed Average_{c} – 10% |
|---|---|---|---|---|---|---|---|---|
| Comparative Example 1* | 1 | 2.82 | 29.136 | 16.17 | 0.555 | 0.587 | 0.528 | – |
| | 2 | 2.78 | 28.723 | 15.92 | 0.554 | | | |
| | 3 | 2.86 | 29.55 | 18.08 | 0.612 | | | |
| | 4 | 2.79 | 28.826 | 17.75 | 0.616 | | | |
| | 5 | 2.79 | 28.826 | 17.18 | 0.596 | | | |
| Example 1 | 1 | 3.09 | 31.926 | 13.86 | 0.434 | 0.415 | | No |
| | 2 | 3.13 | 32.339 | 13.06 | 0.404 | | | |
| | 3 | 3.12 | 32.236 | 13.83 | 0.429 | | | |
| | 4 | 3.13 | 32.339 | 13.01 | 0.402 | | | |
| | 5 | 3.13 | 32.339 | 13.19 | 0.408 | | | |

where, Comparative Example 1* is untreated corrugated

### Burst Strength Determination

As per voluntary standard TAPPI T 403, a specimen in clamped in a Bourdon Gage, overlapping the specimen at all points. Hydrostatic pressure at a specified value was applied until the specimen ruptures, at which point the maximum registered is recorded. This was repeated for at least 5 samples, with the average reported in kPa (or lb/in). If the basis weight was measured, as per TAPP T 410, this can be reported as an index value (burst value/basis weight [in g/m² or lb/1000 ft²]).

TABLE 12

Burst strength determination

| Sample | Replicate | Handsheet weight (g) | Basis Wt. (lb/1000 ft²) | STFI Value [lb_{f}/in] | Indexed Value | Indexed Average | Indexed Average_{c} – 10% | Indexed Average_{g} ≥ Indexed Average_{c} – 10% |
|---|---|---|---|---|---|---|---|---|
| Comparative Example 1* | 1 | 2.84 | 29.343 | 74 | 2.522 | 2.545 | 2.291 | – |
| | 2 | 2.88 | 29.756 | 77.25 | 2.596 | | | |
| | 3 | 2.79 | 28.826 | 73.25 | 2.541 | | | |
| | 4 | 2.83 | 29.24 | 73.25 | 2.505 | | | |
| | 5 | 2.71 | 28.0 | 71.75 | 2.563 | | | |
| Example 1 | 1 | 3.11 | 32.133 | 51.75 | 1.611 | 1.703 | | No |
| | 2 | 3.18 | 32.856 | 56.25 | 1.712 | | | |
| | 3 | 3.14 | 32.442 | 56.5 | 1.742 | | | |
| | 4 | 3.08 | 31.823 | 52.25 | 1.642 | | | |
| | 5 | 3.16 | 32.649 | 59 | 1.807 | | | |

where, Comparative Example 1* is untreated corrugated

The compositions and methods of the appended claims are not limited in scope by the specific compositions and methods described herein, which are intended as illustrations of a few aspects of the claims and any compositions and methods that are functionally equivalent are intended to fall within the scope of the claims. Various modifications of the compositions and methods in addition to those shown and described herein are intended to fall within the scope of the appended claims. Further, while only certain representative compositions and method steps disclosed herein are specifically described, other combinations of the compositions and method steps also are intended to fall within the scope of the appended claims, even if not specifically recited. Thus, a combination of steps, elements, components, or constituents may be explicitly mentioned herein or less, however, other combinations of steps, elements, components, and constituents are included, even though not explicitly stated. The term “comprising”, and variations thereof as used herein is used synonymously with the term “including” and variations thereof and are open, nonlimiting terms. Although the terms “comprising” and “including” have been used herein to describe various embodiments, the terms “consisting essentially of” and “consisting of” can be used in place of “comprising” and “including” to provide for more specific embodiments of the invention and are also disclosed. Other than in the examples, or where otherwise noted, all numbers expressing quantities of ingredients, reaction conditions, and so forth used in the specification and claims are to be understood at the very least, and not as an attempt to limit the application of the doctrine of equivalents to the scope of the claims, to be construed in light of the number of significant digits and ordinary rounding approaches.

### DISCUSSION OF RESULTS

The composition blend prepared according to the present invention (inventive examples) were tested for recyclability and repulpability and the results in Tables 8 and 9 indicate that the inventive examples enable recyclability and repulpability in comparison to a paraffin composition under normal operating procedures. The fiber yield on repulpability is in the range of 95% to 99% as indicated in Table 9.

The composition blend prepared according to the present invention (inventive examples) were tested for block testing, Cobb value, slide angle and water drop penetration and the results in Table 5, 6, 7 and 10 indicate that the inventive examples prepared according to composition disclosed herein provide improved water and moisture resistance, adhesion on coating and block resistance with substantially no damage to the substrate coated with the composition in addition to being recyclable and repulpable.

The composition blend prepared according to the present invention (inventive examples) were tested for short span compression and burst strength and the results in Tables 11 and 12 indicate that the inventive examples prepared by the compositions disclosed herein enables good physical strength of the recycled paper.

The ester and styrene acrylic polymer selection in the composition with the desired characterization as disclosed herein drive the recyclability and repulpability of the coated substrate. The selection of the components in the composition in addition also drive advantageous properties of coated substrate like adhesion, block resistance, water resistance, strength to be independently tailored and targeted for different applications.

### TEST METHODS

### Molecular Weight Determination

Molecular weight was measured by gel permeation chromatography according to ISO 13885-1(2008). Gel permeation chromatography (GPC) spectra were acquired with a Waters 2695 instrument and was used to determine molecular weight of polymers using tetrahydrofuran (THF) as the mobile phase at 40° C. and a refractive index (RI) detector. All samples were analysed for number average molecular weight (Mn), weight average molecular weight (Mw), and polydispersity (PDI) using elution times calibrated against polystyrene molecular weight standards. The number average molecular weight (Mn) is the statistical average molecular weight of all the polymer chains in the polymer and is defined by:

$${\text{M}}_{\text{n}} = \left(\text{Σ} {\text{N}}_{\text{i}} {\text{M}}_{\text{i}}\right) / \text{Σ} {\text{N}}_{\text{i}}$$

where Mi is the molecular weight of a chain and Ni is the number of chains of that molecular weight.

The weight average molecular weight (Mw) is defined by:

$${\text{M}}_{\text{w}} = \left(\text{Σ} {\text{NiMi}}^{2}\right) / \text{Σ} {\text{N}}_{\text{i}}$$

Compared to Mn, Mw considers the molecular weight of a chain in determining contributions to the molecular weight average. The more massive the chain, the more the chain contributes to Mw.

Higher average molecular weights (Mz) can be defined by the equation:

$${\text{M}}_{\text{z}} = \left(\text{Σ} {\text{NiMi}}^{3}\right) / \text{Σ} {\text{N}}_{\text{i}}$$

### Viscosity Determination

The viscosity of the polymer was determined with a TA Ares rheometer using 40 mm cone and plate geometry. The viscosity was determined according to method ASTM 2196-18. Viscosity measurements were conducted at a constant shear rate of 2.85 s⁻¹ and temperatures were increased at 5° C./min from 85-130° C. Viscosity measurements were also carried out at constant temperatures of 90° C., 100° C., 110° C., 120° C., and 130° C. and varying shear rates from 0.1 to 100 s⁻¹.

### Glass Transition Temperature Determination

Glass transition temperature (Tg) was measured by Differential Scanning Calorimetry (DSC) using a heat-cool-heat method according to ASTM D 7426(2013). 1^{st} heat : RT to 150° C. at 10° C./min, cool 150° C. to -50° C. at 10° C./min; 2^{nd} heat: -50° C. to 150 at 10° C./min. 1^{st} and 2^{nd} order transitions are identified and reported as melting point (Tₘ) and T_{g} from the 2^{nd} heat cycle.

### Coat Weight Determination

Coated samples were left to sit in a CTH room at 25° C. and 50% relative humidity for a minimum of 4 hours to equilibrate to a consistent water content. Using a paper cutter, drawdown samples were cut into 5″ × 4″ (12.7 cm × 10.2 cm) rectangles to leave a completely coated sheet. Several 5″ × 4″ control sheets of the liner paper substrate were weighed, and 3 replicates of the coated sample were weighed. The coating weight was calculated as the difference of the coated sample to the control sample.

### Blocking Resistance Determination

Block testing was done at 20 lb_{f} (89 N) and 50° C. for 4 hours. A coated sample of desired coat weight was cut into strips of 1″ (2.54 cm) wide by approximately 4″ (10.2 cm) in length. These samples were stacked together such that two coated faces were in contact and a third coated face was in contact with the uncoated side of either of the other two pieces. This was done in duplicate for each sample and these 3-piece stacks were themselves stacked and placed in a block tester. The spring was screwed down to the desired pressure based on its calibration table and the entire assembly was placed into an oven at the desired temperature.

### Slide Angle Determination

As per the voluntary standard Technical Association of the Pulp and Paper Industry (TAPPI) T 815, slide angle testing uses a 4 lb sled and a motorized track to determine at what angle two coating surfaces will slide past one another. One sample was cut into two 2″×7″ (5.1 cm × 17.8 cm) pieces and, using the scoring template, one piece was scored and folded along the score. The scored and folded sample was wrapped around the sled from the front, underneath, and to the back with the coating facing out. The unscored sample was placed in the clamp on the track with the coating facing up. With the track in the horizontal position the sled was put into place and the track rose until the sled slides forward, cutting off the motor. The angle of the track was measured and recorded.

### Water Drop Penetration Determination

As per the voluntary standard TAPPI T 831, a coated sample was placed on a rack or ring so that the lower (uncoated) side can be observed. A burette or stopper, which will deliver 20 drops/cm³ of distilled or deionized water, was placed 1″ (25 mm) above the top (coated) surface of the sample. A single drop of water was dropped onto the surface of the specimen and a stopwatch was immediately started. The time for penetration of the drop through the sample was recorded when the first visual indication of wetting of the lower surface. This was repeated for at least 5 samples, with the average reported for a particular coating.

### Repulpability Determination

As per the “Voluntary Standard For Repulping and Recycling Corrugated Fiberboard Treated to Improve Its Performance in the Presence of Water and Water Vapor″ from the Fibre Box Association (FBA), a coated sample of corrugated board was cut into 1.25” (31.8 mm) by 4″ (102 mm) strips. Sufficient quantities of these strips were cut to generate 0.055 lb (25 g) of corrugated board. These samples were placed in 1500 mL of water (125° F. ± 10° F. and pH 7 ± 0.5 pH) in a Modified Waring Blender and British Disintegrator, both of which were preheated to 125° F. (± 10° F.). Blending in the 1-gallon Waring blender (equipped with special blades) was done on low speed (15,000 rpm) for 4 minutes. All fibres were rinsed from the blender with 500 mL of hot water. Deflaking was then done for 5 minutes in the British disintegrator (2000 mL total volume) at 3000 rpm. The pulped material was then separated on a 0.010” (0.254 mm) slotted open flat screen, maintaining 1″ (2.54 cm) of water head for 20 minutes. The fibre recovery was then measured as a percentage of the amount of fibre charged. Fibre yield must be at least 80% based on the total weight, or 85% based on bone-dry fibre charge to the pulper. The accepts and rejects were recovered in aluminum weighing pans and dried in a laboratory oven for 12 hours (± 4 hours) at 221° F. (105° C.). The pans were weighed and the net weight of accepts, rejects, and the sum of the accepts and rejects were recorded. The percentage of rejects was then reported to the nearest 0.1%, calculated as below:

$${\% \text{of}}_{\text{Rejects}} = \frac{\text{Net} \text{Rejects} \times 100}{\begin{matrix}\text{Net} \text{Accepts+Net} \\ \text{Rejects}\end{matrix}}$$

### Recyclability Determination

From the accepts from the repulpability process, form handsheets according to TAPPI T 205 with the following conditions: The slurry was vigorously agitated (without causing a change in fibre distribution in the slurry) and maintained at 125° F. (±10° F.) and pH 7 (±0.5 pH). The sheets were dried under restraint to 7% moisture content on a surface dryer maintained at 250 - 275° F. Reconditioned to TAPPI standard conditions prior to testing. Handsheets were tested for basis weight (TAPPI T 220), slide angle (TAPPI T 815), short span compression (STFI)(TAPPI T 826), bursting strength (TAPPI T 403), and water drop penetration (TAPPI T 831).

### Short Span Compression Determination (STFI)

As per voluntary standard TAPPI T 826, a test specimen that is 15 mm (0.59″) wide, was held between two clamps 0.7 mm (0.028″) apart in a compression tester. The compression tester shall be 30 mm (1.18″) deep and have a surface of high friction, for example, a sand-blasted surface. The clamps shall grip the test specimen firmly over its full width with a constant clamping force of 2300 + 500 N (517 ± 112 lb). The stationary jaws shall be on the same side of the test specimen and clamping surfaces of the movable jaws in the same plane and parallel to the stationary jaws. The clamps were forced toward each other until a compressive failure occurs. The maximum force causing failure was measured in kN/m (or lb/in) and reported as an average of a minimum of five tests. If the basis weight was measured, as per TAPP T 410, this can be reported as an index value (STFI value/basis weight [in g/m² or lb/1000 ft²]).

### Burst Strength Determination

As per voluntary standard TAPPI T 403, a specimen in clamped in a Bourdon Gage, overlapping the specimen at all points. Hydrostatic pressure at a specified value was applied until the specimen ruptures, at which point the maximum registered is recorded. This was repeated for at least 5 samples, with the average reported in kPa (or lb/in). If the basis weight was measured, as per TAPP T 410, this can be reported as an index value (burst value/basis weight [in g/m² or lb/1000 ft²]).

1. A composition comprising:
(i) at least one ester obtained by reacting at least one compound having 2 to 12 hydroxy groups and at least one C₆-C₂₄ monocarboxylic acid; and
(ii) at least one first styrene acrylic copolymer with a glass transition temperature in the range of from - 54° C. to 10° C., measured by differential scanning calorimetry according to ASTM D 7426 (2013).

2. The composition according to claim 1, wherein the at least one ester has melting point in the range of 50° C. to 90° C., determined according to ASTM D3418-15.

3. The composition according to claim 1, wherein the at least one compound having 2 to 12 hydroxy groups is selected from the group consisting of ethylene glycol, glycerol, erythritol, pentaerythritol, mesoerythritol, 1,2,6-hexanetriol, sorbitol, trimethylolpropane, 1,2,4-butanetriol, trimethylolethane, arabitol, xylitol, mannitol, dipentaerythritol, monosaccharides, disaccharides and polysaccharides.

4. The composition according to claim 3, wherein the monosaccharides are selected from the group consisting of ribose, ribulose, arabinose, xylose, lyxose, glucose, fructose, galactose, mannose and sorbose.

5. The composition according to claim 3, wherein the polysaccharides are selected from the group consisting of dextrin and maltodextrin.

6. The composition according to claim 3, wherein the disaccharides are selected from the group consisting of maltose, sucrose and lactose.

7. The composition according to claim 1, wherein the at least one compound has 2 to 4 hydroxy groups.

8. The composition according to claim 7, wherein the at least one compound having 2 to 4 hydroxy groups is selected from the group consisting of ethylene glycol, glycerol, erythritol, pentaerythritol, mesoerythritol, 1,2,6-hexanetriol and trimethylolpropane.

9. The composition according to claim 1, wherein the at least one compound has 3 or 4 hydroxy groups.

10. The composition according to claim 9, wherein the at least one compound having 3 or 4 hydroxy groups is selected from the group consisting of glycerol, erythritol, pentaerythritol, mesoerythritol, 1,2,6-hexanetriol and trimethylolpropane.

11. The composition according to claim 1, wherein the at least one compound has 4 hydroxy groups.

12. The composition according to claim 11, wherein the at least one compound having 4 hydroxy groups is selected from the group consisting of pentaerythritol, ribose, ribulose, arabinose, xylose, erythritol and mesoerythritol.

13. The composition according to claim 1, wherein the at least one ester is selected from the group consisting of pentaerythritol tetrastearate, pentaerythritol oleate, pentaerythritol tetrabehenate, pentaerythritol tetraisopalmitate, glyceryl tristearate, erythritol distearate, sorbitan stearate and dipentaerythritol stearate.

14. The composition according to claim 1, wherein the at least one C₆-C₂₄ monocarboxylic acid is selected from the group consisting of caproic acid, caprylic acid, capric acid, lauric acid, myristic acid, palmitic acid, stearic acid, oleic acid and behenic acid.

15. The composition according to claim 1, wherein the at least one ester is present in an amount in the range of 20 wt.% to 70 wt.%, based on the total weight of the coating composition.

16. The composition according to claim 1, wherein the at least one first styrene acrylic copolymer is present in an amount in the range of 20 wt.% to 60 wt.%, based on the total weight of the coating composition.

17. The composition according to claim 1, wherein the at least one first styrene acrylic copolymer has a weight average molecular weight in the range of 1000 g/mol to 25,000 g/mol, measured by gel permeation chromatography according to ISO 13885-1 (2008).

18. The composition according to claim 1, wherein the at least one styrene monomer is selected from the group consisting of styrene, 1,3-dimethylstyrene, chlorostyrene, bromostyrene, α- methylstyrene, m-methylstyrene, p-methylstyrene, α-butylstyrene, 4-n-butylstyrene, 4-n-decylstyrene and combinations thereof.

19. The composition according to claim 1, further comprising at least one second styrene acrylic copolymer with a glass transition temperature in the range of from 60° C. to 150° C., measured by differential scanning calorimetry according to ASTM D 7426 (2013).

20. The composition according to claim 19, wherein the at least one second styrene acrylic copolymer is present in an amount in the range of 10 wt.% to 40 wt.%, based on the total weight of the coating composition.

21. The composition according to claim 19, wherein the at least one second styrene acrylic copolymer has a weight average molecular weight in the range of 1000 g/mol to 15,000 g/mol, measured by gel permeation chromatography according to ISO 13885-1 (2008).

22. The composition according to claim 19, wherein the at least one second styrene acrylic copolymer comprises at least one styrene monomerselected from the group consisting of styrene, 1,3-dimethylstyrene, chlorostyrene, bromostyrene, α-methylstyrene, m-methylstyrene, p-methylstyrene, α-butylstyrene, 4-n-butylstyrene, 4-n-decylstyrene and combinations thereof.

23. The composition according to claim 1, further comprising at least one rheology modifier.

24. The composition according to claim 23, wherein the at least one rheology modifier is present in an amount in the range of 0.5 wt.% to 4.0 wt.%, based on the total weight of the coating composition.

25. The composition according to claim 1, further comprising at least one anti-blocking agent.

26. The composition according to claim 25, wherein the at least one anti-blocking agent is present in an amount in the range of 0.5 wt.% to 3 wt.%, based on the total weight of the coating composition.

27. The composition according to claim 1, wherein the melt viscosity of the composition is in the range of 100 cP to 2000 cP at temperature in the range of 90° C. to 130° C., determined according to method ASTM 2196 (2018).

28. A process for preparing the composition according to claim 1 comprising at least the steps of:
(i) mixing at least one ester and at least one first styrene acrylic copolymer to form a mixture; and
(ii) heating the mixture to a temperature in the range of from 90° C. to 140° C., wherein the at least one ester is obtained by reacting at least one compound having 2 to 12 hydroxy groups and at least one C₆-C₂₄ monocarboxylic acid.

29. A coating comprising the composition according to claim 1.

30. A substrate coated on at least one surface with the coating according to claim 29.

31. The substrate according to claim 30, wherein the substrate is selected from the group consisting of coated paper, uncoated paper and paperboard.

32. Paper stock comprising a substrate coated with the coating according to claim 29.
